(19) United States
(12) Patent Application Publication
(10) Pub. No.: US 2022/0391973 A1
(43) Pub. Date: Dec. 8, 2022

(54) SYSTEMS AND METHODS FOR GRADUATION OF DUAL-FEATURE PAYMENT INSTRUMENTS

(71) Applicant: Synchrony Bank, Stamford, CT (US)

(72) Inventors: Gregg Peters, Stamford, CT (US); Falko Kloepper, Stamford, CT (US); Patrick Gamgort, Stamford, CT (US)

(21) Appl. No.: 17/830,449

(22) Filed: Jun. 2, 2022

Related U.S. Application Data
(60) Provisional application No. 63/196,065, filed on Jun. 2, 2021.

(51) Int. Cl. G06Q 40/02; G06Q 20/38; G06N 20/00

(52) U.S. Cl. CPC G06Q 40/02; G06Q 20/389; G06N 20/00

(57) ABSTRACT

Systems and methods for graduating a secured dual-feature payment instrument to an unsecured dual-feature payment instrument are provided. A secured dual-feature payment instrument may be secured by a security deposit and associated with an account and a computational model with the account. The computational model may then be updated by continually applying a machine learning model to transactions of the account. The updated computational model may then be used to determine whether to offer graduation of the secured dual-feature payment instrument to an unsecured dual-feature payment instrument. If it is determined to offer graduation, the offer may be communicated and, if the offer is accepted, the secured dual-feature payment instrument may be graduated to an unsecured dual-feature payment instrument.

### CROSS-REFERENCE TO RELATED APPLICATIONS

The present patent application claims the priority benefit of U.S. provisional patent application No. 63/196,065 filed Jun. 2, 2021, the disclosures of which are incorporated by reference herein.

### FIELD

The present disclosure relates generally to secured and unsecured payment instruments associated with an account. In one example, the systems and methods described herein may be used to monitor secured payment instruments, to identify secured payment instruments that may be graduated to unsecured payment instruments, and to present an offer of graduation to a holder of the account. Upon receiving an acceptance of the offer of graduation, the systems and methods described herein may then graduate the secured payment instrument to an unsecured payment instrument. Further, the systems and methods described herein may be used to continuously update the monitoring system for the secured payment instruments and to provide improved fidelity of the offers for graduation.

### SUMMARY

Disclosed embodiments may provide a framework to monitor secured payment instruments, identify secured payment instruments that may be graduated to unsecured payment instruments, and present offers of graduation to account holders associated with secured payment instruments. According to some embodiments, a computer-implemented method is provided. The computer-implemented method comprises generating a secured dual-feature payment instrument. The secured dual-feature payment instrument is secured by a security deposit. Further, the secured dual-feature payment instrument is associated with a user account. The computer-implemented method further comprises associating a computational model with the user account and an account holder. The computer-implemented method further comprises updating the computational model by continually applying a machine learning model to one or more transactions associated with the user account and the account holder. The computer-implemented method further comprises using the computational model to determine whether to generate an offer to graduate the secured dual-feature payment instrument to an unsecured dual-feature payment instrument. The computer-implemented method further comprises communicating the offer to graduate the secured dual-feature payment instrument to the unsecured dual-feature payment instrument. When the offer is received by the account holder, the account holder determines whether to provide an acceptance of the offer. The computer-implemented method further comprises receiving the acceptance of the offer. The computer-implemented method further comprises graduating the secured dual-feature payment instrument to the unsecured dual-feature payment instrument.

In some embodiments, the transactions associated with the user account and the account holder include transactions conducted using the secured dual-feature payment instrument.

In some embodiments, the transactions associated with the user account and the account holder include transactions reported to a credit reporting service.

In some embodiments, the computer-implemented method further comprises returning the security deposit to the account holder in response to receiving the acceptance of the offer.

In some embodiments, the computer-implemented method further comprises updating the computational model using one or more financial rules. The one or more financial rules are associated with a financial institution associated with the user account.

In some embodiments, the computer-implemented method further comprises determining a future time to communicate the offer to graduate the secured dual-feature payment instrument to the unsecured dual-feature payment instrument. The future time is determined using the computational model.

In some embodiments, the computer-implemented method further comprises providing the account holder with a set of terms and conditions associated with the secured dual-feature payment instrument when providing the secured dual-feature payment instrument to the holder of the account. Further, the computer-implemented method comprises providing the account holder with the set of terms and conditions associated with the secured dual-feature payment instrument when communicating the offer of graduation.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which an offer of graduation of a secured dual-feature payment instrument to an unsecured dual-feature payment instrument is presented to an account holder in accordance with at least one embodiment;

FIG. 2 shows an illustrative example of an environment in which an application for a secured dual-feature payment instrument is processed in accordance with at least one embodiment;

FIG. 3 shows an illustrative example of an environment in which an offer of graduation of a secured dual-feature payment instrument to an unsecured dual-feature payment instrument is accepted by an account holder in accordance with at least one embodiment;

FIG. 4 shows an illustrative example of an environment in which a secured dual-feature payment instrument is monitored to determine whether an offer of graduation should be presented in accordance with at least one embodiment;

FIG. 5 shows an illustrative example of a process in which an offer of graduation of a secured dual-feature payment instrument to an unsecured dual-feature payment instrument is presented to an account holder in accordance with at least one embodiment;

FIG. 6 shows an illustrative example of an environment in which a graduation determination system determines whether to graduate a secured dual-feature payment instrument to an unsecured dual-feature payment instrument in accordance with at least one embodiment;

FIG. 7 shows an illustrative example of a process in which a graduation determination system determines whether to graduate a secured dual-feature payment instrument to an unsecured dual-feature payment instrument in accordance with at least one embodiment;

FIG. 8 shows an illustrative example of an environment in which the data flow for an offer of graduation of a secured dual-feature payment instrument to an unsecured dual-feature payment instrument is presented to an account holder in accordance with at least one embodiment;

FIG. 9 shows an illustrative example of an environment in which the first part of a data flow for the graduation of a secured dual-feature payment instrument to an unsecured dual-feature payment instrument is illustrated in accordance with at least one embodiment;

FIG. 10 shows an illustrative example of an environment in which the second part of a data flow for the graduation of a secured dual-feature payment instrument to an unsecured dual-feature payment instrument is illustrated in accordance with at least one embodiment;

FIG. 11 shows an illustrative example of an environment in which the third part of a data flow for the graduation of a secured dual-feature payment instrument to an unsecured dual-feature payment instrument is illustrated in accordance with at least one embodiment;

FIG. 12 shows an illustrative example of an environment in which an application for a secured dual-feature payment instrument is presented in accordance with at least one embodiment;

FIG. 13 shows an illustrative example of an environment in which an offer of graduation of a secured dual-feature payment instrument to an unsecured dual-feature payment instrument is presented in accordance with at least one embodiment;

FIG. 14 shows an illustrative example of an environment in which an application for a secured dual-feature payment instrument is initiated in accordance with at least one embodiment; and

FIG. 15 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

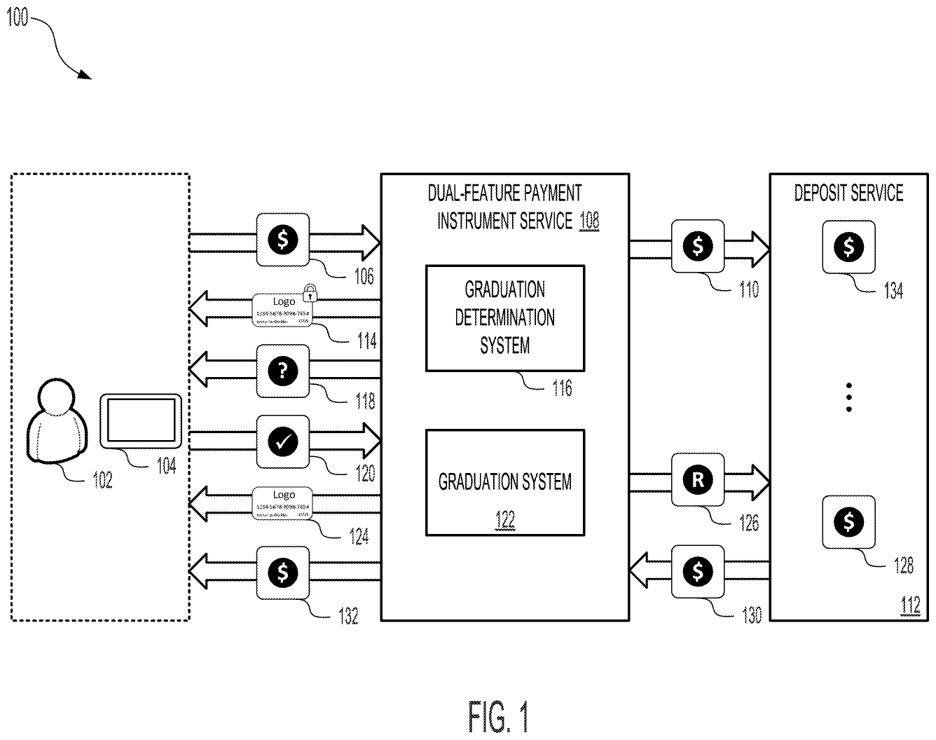

Additionally, in the appended figures, similar components and/or features may refer back to an earlier described component. For example, a component and/or feature may be described as “ . . . the dual-feature payment instrument service 210 (which is the same as the dual-feature payment instrument service 108 described herein at least in connection with FIG. 1) . . . .” Such references are bi-directional in that, a later reference back such as “ . . . the dual-feature payment instrument service 306 (which is the same as the dual-feature payment instrument service 108 described herein at least in connection with FIG. 1) . . . ” is indicative that components and/or features described with respect to the dual-feature payment instrument service 108 and with respect to the dual-feature payment instrument service 210 are both incorporated into the components and/or features of the dual-feature payment instrument service 306 and vice versa.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework where a dual-feature payment instrument service may provide systems and methods to process applications for secured dual-feature payment instruments and issue secured dual-feature payment instruments to applicants for secured dual-feature payment instruments. The dual-feature payment instrument service may also provide systems and methods to receive deposits used to secure secured dual-feature payment instruments from account holders associated with the secured dual-feature payment instruments. The dual-feature payment instrument service may also provide systems and methods to process transactions of secured dual-feature payment instruments and as a result of those transactions and other factors, may provide systems and methods to determine whether a secured dual-feature payment instrument should be graduated to an unsecured dual-feature payment instrument. The dual-feature payment instrument service may also provide systems and methods to process the graduation of the secured dual-feature payment instrument to an unsecured dual-feature payment instrument, issue an unsecured dual-feature payment instrument and/or convert a secured dual-feature payment instrument to an unsecured dual-feature payment instrument, and process transactions of unsecured dual-feature payment instruments. The systems and methods to process the graduation of the secured dual-feature payment instrument to an unsecured dual-feature payment instrument may also be referred to herein as systems and methods to process the promotion of the secured dual-feature payment instrument to an unsecured dual-feature payment instrument. That is, as used herein, discussions of the systems and methods to process the graduation of the secured dual-feature payment instrument to an unsecured dual-feature payment instrument may also be understood to encompass systems and methods to process the promotion of the secured dual-feature payment instrument to an unsecured dual-feature payment instrument. For example, discussion of an operation to communicate an offer to opt-in for the graduation of a secured dual-feature payment instrument to an unsecured dual-feature payment instrument encompasses an operation to communicate an offer to opt-in for the promotion of a secured dual-feature payment instrument to an unsecured dual-feature payment instrument.

A secured dual-feature payment instrument may be a payment instrument associated with an account that is secured by a deposit provided by an account holder and held in escrow by the dual-feature payment instrument service. An unsecured dual-feature payment instrument may be a payment instrument associated with an account that is not secured by a deposit. Graduation of a secured dual-feature payment instrument to an unsecured dual-feature payment instrument may include converting the secured dual-feature payment instrument to an unsecured dual-feature payment instrument by, for example, returning the security deposit for the dual-feature payment instrument, adjusting the credit limit of the dual-feature payment instrument, updating various credit reporting agencies of the graduation, and other such operations. Graduation of a secured dual-feature payment instrument to an unsecured dual-feature payment instrument may also be referred to herein as a promotion of a secured dual-feature payment instrument to an unsecured dual-feature payment instrument.

As used herein and unless otherwise made expressly clear, “promotion” of a secured dual-feature payment instrument to an unsecured dual-feature payment instrument refers to the systems and methods described herein for graduating a secured dual-feature payment instrument to an unsecured dual-feature payment instrument rather than the conventional meaning of “promotion” (i.e., offering an incentive to promote participation or engagement with services associated with the dual-feature payment instrument).

FIG. 1 shows an illustrative example of an environment 100 in which an offer of graduation of a secured dual-feature payment instrument to an unsecured dual-feature payment instrument is presented to an account holder in accordance with at least one embodiment. More specifically, FIG. 1 illustrates the establishment of a secured dual-feature payment instrument, determination of an offer for graduation (or promotion) of the secured dual-feature payment instrument to an unsecured dual-feature payment instrument, presentation of the offer for graduation (or promotion), acceptance of the offer, and the graduation (or promotion) of the secured dual-feature payment instrument to an unsecured dual-feature payment instrument.

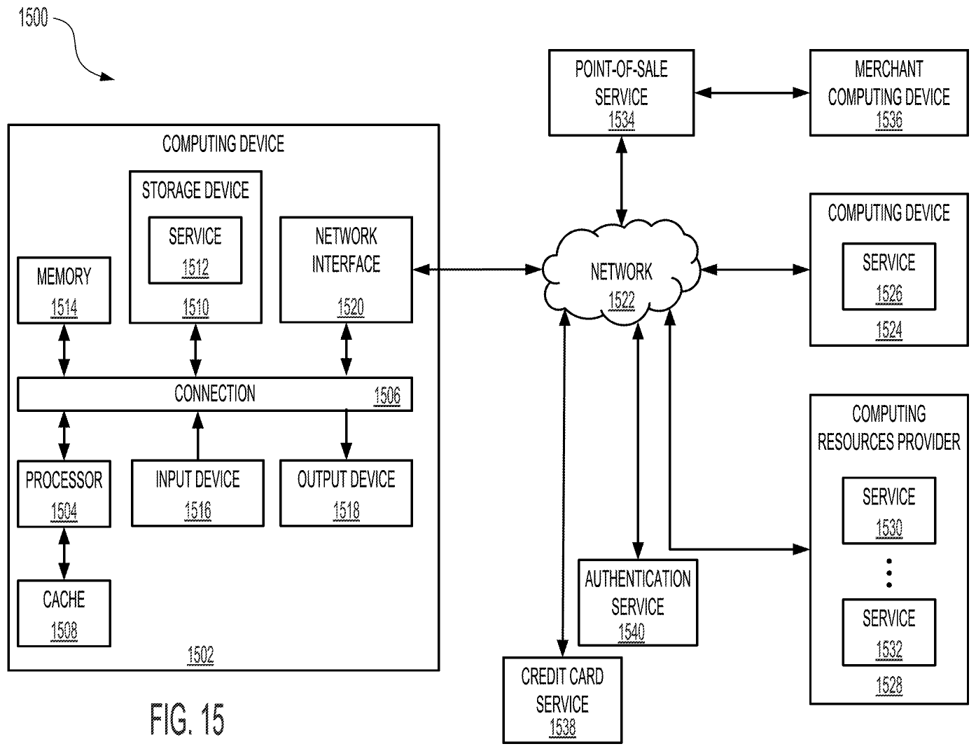

In an embodiment, an account holder 102 uses a computing device 104 (e.g., a laptop computer, desktop computer, smart phone, etc.) to provide a security deposit 106 to a dual-feature payment instrument service 108. In an embodiment, the account holder 102 is a user associated with an account provided by the dual-feature payment instrument service 108. In an embodiment, the account holder 102 is a user associated with an account provided by a third-party (e.g., a payment instrument service such as the payment instrument service 1538 described herein at least in connection with FIG. 15). In an embodiment, the account holder 102 is a user associated with an account provided by a merchant (e.g., a merchant such as the merchant described herein at least in connection with FIG. 15). In an embodiment, the account holder 102 is a user associated with an account provided by an online merchant (e.g., a merchant operating via a computing resources provider such as the computing resources provider 1528 described herein at least in connection with FIG. 15).

In an embodiment, the account holder 102 can be an automated process that may be configured to automatically interact with transactions associated with the account. For instance, responses provided by a user during the creation of the account may be provided as input to a machine learning algorithm, an artificial intelligence system, or a computational model to interact with transactions associated with the account on behalf of the user associated with the account. The automated process may be configured according to the parameters or characteristics of the user. As the automated process interacts over time, the automated process may be updated to improve that interaction.

In an embodiment, the computing device 104 is a computing device such as the computing device 1502 described herein at least in connection with FIG. 15. In an embodiment, the computing device is a merchant computing device such as the merchant computing device 1536 described herein at least in connection with FIG. 15. In an embodiment, the computing device 104 is a virtual computing device that is hosted by a service of a computing resources provider such as the computing resource provider 1528 described herein at least in connection with FIG. 15 (e.g., the service 1530 and/or the service 1532 described herein at least in connection with FIG. 15).

In an embodiment, the account holder 102 interacts with the dual-feature payment instrument service 108 using an application running on the device 104. In an embodiment, the application running on the device 104 is an application provided by the dual-feature payment instrument service 108 that runs on the device 104. In an embodiment, the application can be accessed using a web page or a web portal provided by the dual-feature payment instrument service 108 and the interactions with the dual-feature payment instrument service may be displayed on the device 104.

In an embodiment, the dual-feature payment instrument service 108 is a service that, for example, processes applications for secured dual-feature payment instruments, issues secured dual-feature payment instruments, receives deposits used to secure secured dual-feature payment instruments, processes transactions of secured dual-feature payment instruments, determines whether a secured dual-feature payment instrument should be graduated to an unsecured dual-feature payment instrument, processes the graduation of the secured dual-feature payment instrument to an unsecured dual-feature payment instrument, issues unsecured dual-feature payment instruments, processes transactions of unsecured dual-feature payment instruments, and performs other such operations. In an embodiment, the dual-feature payment instrument service 108 is a service such as the service 1512 described herein at least in connection with FIG. 15. In an embodiment, the dual-feature payment instrument service 108 is a service provided by a merchant such as the merchants described herein at least in connection with FIG. 15. In an embodiment, the dual-feature payment instrument service 108 is a service provided by a computing resources provider such as the computing resource provide 1528 described herein at least in connection with FIG. 15 (e.g., a service such as service 1530 and/or service 1532 described herein at least in connection with FIG. 15). In an embodiment, the dual-feature payment instrument service 108 is a payment instrument service such as the payment instrument service 1538 described herein at least in connection with FIG. 15. In some embodiments, the dual-feature payment instrument service 108 is a service operated by the issuer of the secured dual-feature payment instrument and/or the unsecured dual-feature payment instrument. In some embodiments, the dual-feature payment instrument service 108 is a service operated by a third-party on behalf of the issuer of the secured dual-feature payment instrument and/or the unsecured dual-feature payment instrument.

As described above, in an embodiment the account holder 102 uses the computing device 104 to provide the security deposit 106 to the dual-feature payment instrument service 108. In an embodiment, the security deposit 106 is a deposit that is provided by the account holder 102 that may be used to provide secured funds for charges made using the dual-feature payment instrument. For example, a secured dual-feature payment instrument may have a credit limit of five-hundred dollars (i.e., have an unpaid balance of up to five-hundred dollars). Such a secured dual-feature payment instrument may be secured by a deposit of five-hundred dollars. In an embodiment, a security deposit 106 for a secured dual-feature payment instrument is equal to the credit limit of the secured dual-feature payment instrument (e.g., the security deposit 106 is five-hundred dollars for a secured dual-feature payment instrument with a credit limit of five-hundred dollars). In an embodiment, a security deposit 106 for a secured dual-feature payment instrument is less than the credit limit of the secured dual-feature payment instrument (e.g., the security deposit 106 is two-hundred dollars for a secured dual-feature payment instrument with a credit limit of five-hundred dollars). In an embodiment, a security deposit 106 for a secured dual-feature payment instrument is less than the credit limit of the secured dual-feature payment instrument (e.g., the security deposit 106 is one-thousand dollars for a secured dual-feature payment instrument with a credit limit of five-hundred dollars).

In an embodiment, when the dual-feature payment instrument service 108 receives the deposit 106, the dual-feature payment instrument service 108 provides the deposit 110 to a deposit service 112 and the deposit service 112 holds the deposit in escrow (i.e., as an escrowed deposit 134) on behalf of the dual-feature payment instrument service 108. In an embodiment, the deposit service 112 holds the security deposit in an account and the funds of the security deposit are released when certain conditions are met. For example, the deposit service 112 may release the funds when the secured dual-feature payment instrument is graduated to an unsecured dual-feature payment instrument, as described herein. In another example, the deposit service 112 may release the funds when a balance of the secured dual-feature payment instrument remains unpaid for a period of time. In such an example, the deposit service 112 may release the funds to the dual-feature payment instrument service 108, the dual-feature payment instrument service 108 may use a portion of the released funds to satisfy any outstanding balance remaining on the secured dual-feature payment instrument and then return any balance to the account holder 102. In another example, the deposit service 112 may release the funds when the account associated with the secured dual-feature payment instrument is closed.

In an embodiment, the deposit service 112 is a component of the dual-feature payment instrument service 108. In an embodiment, the deposit service 112 is a third-party service that operates separately from the dual-feature payment instrument service. In an embodiment, the deposit service is associated with a payment instrument service such as the payment instrument service 1538 described herein at least in connection with FIG. 15. In an embodiment, the deposit service 112 is a service such as the service 1530 or the service 1532 operating within an environment of computing resources provider such as the computing resources provider 1528 (all described herein at least in connection with FIG. 15).

In an embodiment, when the dual-feature payment instrument service 108 receives the deposit 106, the dual-feature payment instrument service 108 provides a secured dual-feature payment instrument 114 to the account holder 102. In an embodiment, the dual-feature payment instrument service 108 provides a physical secured dual-feature payment instrument 114 to the account holder 102 (e.g., by mailing a physical card to the account holder 102). In an embodiment, the dual-feature payment instrument service 108 provides a virtual secured dual-feature payment instrument 114 to the account holder 102 by, for example, establishing an account for the account holder 102 using a payment instrument service such as the payment instrument service 1538 described herein at least in connection with FIG. 15. In an embodiment, the dual-feature payment instrument service 108 provides a virtual secured dual-feature payment instrument 114 to the account holder 102 by, for example, establishing an account for the account holder 102 using a service provided by a merchant such as the merchant described herein at least in connection with FIG. 15. In an embodiment, the dual-feature payment instrument service 108 provides a virtual secured dual-feature payment instrument 114 to the account holder 102 by, for example, establishing an account for the account holder 102 using a service provided by a computing resources provider such as the computing resources provider 1528 described herein at least in connection with FIG. 15 (e.g., the service 1530 and/or the service 1532 also described herein at least in connection with FIG. 15). In such an embodiment, the virtual secured dual-feature payment instrument may be implemented in a digital wallet usable by the account holder via a device such as a smart phone, smart watch, or other such device. In such an embodiment, the virtual secured dual-feature payment instrument may also be implemented so that it is associated with an online account (e.g., PayPal®, Venmo®, etc.) and is usable only in association with that online account.

In an embodiment, a graduation determination system 116 of the dual-feature payment instrument service 108 monitors transactions of one or more secured dual-feature payment instruments (e.g., the secured dual-feature payment instrument 114) and makes a determination of when to communicate an offer of graduation 118 to the account holder 102. In an embodiment, the graduation determination system 116 communicates the offer of graduation 118 to the account holder 102 using an application running on the device 104. In an embodiment, the application running on the device 104 is an application provided by the dual-feature payment instrument service 108 that runs on the device 104. In an embodiment, the application can be accessed using a web page or a web portal provided by the dual-feature payment instrument service 108 and the interactions with the dual-feature payment instrument service may be displayed on the device 104. In an embodiment, the application running on the device 104 to communicate the offer of graduation 118 is the same as the application running on the device that is used to interact with the dual-feature payment instrument service to, for example, send the deposit 106 to the dual-feature payment instrument service. In an embodiment, the application running on the device 104 to communicate the offer of graduation 118 is a different application than the application running on the device that is used to interact with the dual-feature payment instrument service to, for example, send the deposit 106 to the dual-feature payment instrument service.

As may be contemplated, the various operations described herein to communicate between the account holder 102 and the dual-feature payment instrument service 108 as well as to manage other communications between the dual-feature payment instrument service 108 and other elements described herein may be performed by the same applications, may be performed separate applications, or may be performed by a combination of the same and separate applications.

In an embodiment, the graduation determination system 116 is a system that determines whether a secured dual-feature payment instrument should be graduated to an unsecured dual-feature payment instrument and triggers the processing of the graduation of the secured dual-feature payment instrument to an unsecured dual-feature payment instrument. The systems and methods that the graduation determination system 116 uses to determine whether a secured dual-feature payment instrument should be graduated to an unsecured dual-feature payment instrument and to trigger the processing of the graduation of the secured dual-feature payment instrument to an unsecured dual-feature payment instrument are described in more detail herein below. In an embodiment, and as illustrated in FIG. 1, the graduation determination system 116 is an element of the dual-feature payment instrument service 108. In an embodiment, the graduation determination system 116 is separate from the dual-feature payment instrument service 108. In an embodiment, the graduation determination system 116 is implemented as a service such as the service 1512 described herein at least in connection with FIG. 15. In an embodiment, the graduation determination system 116 is implemented as a service provided by a merchant such as the merchants described herein at least in connection with FIG. 15. In an embodiment, the graduation determination system 116 is implemented as a service provided by a computing resources provider such as the computing resource provide 1528 described herein at least in connection with FIG. 15 (e.g., a service such as service 1530 and/or service 1532, both described herein at least in connection with FIG. 15). In an embodiment, the graduation determination system 116 is implemented as a service such as the payment instrument service 1538 described herein at least in connection with FIG. 15. In some embodiments, the graduation determination system 116 is implemented as a service operated by the issuer of the secured dual-feature payment instrument and/or the unsecured dual-feature payment instrument. In some embodiments, the graduation determination system 116 is implemented as a service operated by a third-party on behalf of the issuer of the secured dual-feature payment instrument and/or the unsecured dual-feature payment instrument.

In an embodiment, the graduation determination system 116 utilizes a machine learning algorithm or an artificial intelligence system to determine whether a secured dual-feature payment instrument should be graduated to an unsecured dual-feature payment instrument and/or to trigger the processing of the graduation of the secured dual-feature payment instrument to an unsecured dual-feature payment instrument. For example, the graduation determination system 116 may implement a clustering algorithm to identify similar accounts, account holders, and/or secured dual-feature payment instruments based on one or more vectors (e.g., spending habits, credit limits, payment performance, demographic information, credit scores, changes in credit scores, etc.). In some instances, a dataset of characteristics of accounts, account holders, and/or secured dual-feature payment instruments may be analyzed using a clustering algorithm to determine whether a secured dual-feature payment instrument should be graduated to an unsecured dual-feature payment instrument and/or to trigger the processing of the graduation of the secured dual-feature payment instrument to an unsecured dual-feature payment instrument. Example clustering algorithms may be trained using the collected dataset. In an embodiment, clustering algorithms are trained using sample datasets of characteristics of accounts, account holders, and/or secured dual-feature payment instruments to classify accounts, account holders, and/or secured dual-feature payment instruments in order to identify secured dual-feature payment instruments should be graduated to unsecured dual-feature payment instruments and/or to trigger the processing of the graduation of the secured dual-feature payment instrument to an unsecured dual-feature payment instrument. Examples of such clustering algorithms may include, but may not be limited to k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output of the machine learning algorithm built from an individual account, account holder, and/or secured dual-feature payment instrument, a determination of whether a secured dual-feature payment instrument should be graduated to an unsecured dual-feature payment instrument and/or whether to trigger the processing of the graduation of the secured dual-feature payment instrument to an unsecured dual-feature payment instrument, the graduation determination system 116 may prompt the account holder 102 to provide a response as to whether the account holder 102 wishes to have the secured dual-feature payment instrument graduated to an unsecured dual-feature payment instrument.

In an embodiment, the graduation determination system 116, the dual-feature payment instrument service 108, or another service of the dual-feature payment instrument service 108 generates a computational model and associates the computational model with the account, the account holder, and/or the secured dual-feature payment instrument. In an embodiment, the computational model (not illustrated in FIG. 1) is an algorithmic representation of an account profile that is used by the graduation determination system 116 to make determinations as to whether a secured dual-feature payment instrument should be graduated to an unsecured dual-feature payment instrument and/or to trigger the processing of the graduation of the secured dual-feature payment instrument to an unsecured dual-feature payment instrument. As described herein, the determinations as to whether a secured dual-feature payment instrument should be graduated to an unsecured dual-feature payment instrument and/or to trigger the processing of the graduation of the secured dual-feature payment instrument to an unsecured dual-feature payment instrument may be based on spending habits of the account holder, credit limits of the account, payment performance on the account, demographic information of the account holder, credit scores (i.e., reported by a credit reporting service), changes in credit scores or spending habits, and/or other such information. In an embodiment, the graduation determination system 116 uses the computational model in conjunction with the machine learning algorithm and/or the artificial intelligence system described herein.

In an embodiment, the computational model is dynamically and continuously updated by the graduation determination system 116 during the existence of the account associated with the account holder and/or the dual-feature payment instrument (secured or unsecured). As used herein, a computational model is a set of one or more computer algorithms that may be executed on computer systems (e.g., computer systems of the dual-feature payment instrument service 108) to model a particular system. In this instance, the computational model is a model that is associated with the account, the account holder, and/or the dual-feature payment instrument. In an embodiment, the computational model is updated through interactions with the dual-feature payment instrument service 108 (e.g., spending transactions, changes to credit scores, changes in spending habits, etc.). In an embodiment, the computational model is updated continuously and dynamically so that, for example, as new transactions are processed and/or as changes to a credit score are detected, those transactions and/or changes are detected and the computational model is updated in real-time. It should be noted that a computational model is used to solve complex systems such as the system to make determinations as to whether a secured dual-feature payment instrument should be graduated to an unsecured dual-feature payment instrument and/or to trigger the processing of the graduation of the secured dual-feature payment instrument to an unsecured dual-feature payment instrument. In simple systems, such determinations as to whether a secured dual-feature payment instrument should be graduated to an unsecured dual-feature payment instrument and/or to trigger the processing of the graduation of the secured dual-feature payment instrument to an unsecured dual-feature payment instrument might be analytically solved. However, in complex systems such as those described herein, such determinations as to whether a secured dual-feature payment instrument should be graduated to an unsecured dual-feature payment instrument and/or to trigger the processing of the graduation of the secured dual-feature payment instrument to an unsecured dual-feature payment instrument may not be easily analytically solved. Such a system may be complex and nonlinear and, accordingly, an analytical solution may not readily apparent. A computational model is used in such systems to, for example, provide iterative experimentation on the model by adjusting parameters of the model using the computer systems and then making predictions about the model based on these iterative experiments. Such computational models may also be referred to as simulations and/or simulation models. There are many different types of computational models including, but not limited to, neural network models, computational cognition, time-reversible models, agent-based models, and so on.

In an embodiment, the computational model is updated by evaluating predictions (e.g., predictions as to whether a secured dual-feature payment instrument should be graduated to an unsecured dual-feature payment instrument and/or to trigger the processing of the graduation of the secured dual-feature payment instrument to an unsecured dual-feature payment instrument) and using that evaluation to further tune the computational model. For example, graduation of a secured dual-feature payment instrument to an unsecured dual-feature payment instrument may be modeled and the computational model may model a likely positive outcome of the graduation. A simulation of that graduation (based either on real or hypothetical data) may then be used to evaluate the efficacy of the modelled prediction of the likely positive outcome of the graduation. The evaluation of the efficacy of the modelled prediction may then be used to update the computational model. Similarly, actual data from other graduations of other secured dual-feature payment instruments and for other accounts may also be used to update the computational model. Determinations about the applicability of information obtained from other accounts, other account holders, and/or other dual-feature payment instruments (secured or unsecured) may be made using machine learning algorithms and/or artificial intelligence techniques such as those described herein.

In an embodiment, the offer for graduation 118 includes information such as the terms for the graduation, an interest rate of the unsecured dual-feature payment instrument, a credit limit of the unsecured dual-feature payment instrument, when the graduation will be effective, whether the graduation is automatically accepted or automatically rejected based on no response by a certain date, and other such information. In an embodiment, the information (e.g., the terms for the graduation, an interest rate of the unsecured dual-feature payment instrument, a credit limit of the unsecured dual-feature payment instrument, when the graduation will be effective, whether the graduation is automatically accepted or automatically rejected based on no response by a certain date) included with the offer for graduation 118 is provided to the account holder 102 at a time when the account and/or the secured dual-feature payment instrument is created. In an embodiment, the information included with the offer for graduation 118 changes during the existence of the account and/or the secured dual-feature payment instrument. In such an embodiment, changes to the information such as the terms for the graduation, an interest rate of the unsecured dual-feature payment instrument, a credit limit of the unsecured dual-feature payment instrument, when the graduation will be effective, whether the graduation is automatically accepted or automatically rejected based on no response by a certain date may be communicated to the account holder at a time when the changes occur. In such an embodiment, the account holder 102 may have an opportunity to accept or reject the changes by, for example, closing the account associated with the secured dual-feature payment instrument.

In an embodiment, the account holder 102 provides a response 120 to the offer for graduation 118. As illustrated in FIG. 1, the account holder 102 may provide a response 120 to the offer for graduation 118 that is an acceptance of the offer for graduation. In an embodiment, the account holder 102 may provide a response 120 to the offer for graduation 118 that is a rejection of the offer for graduation. In an embodiment, the account holder 102 may provide a response 120 to the offer for graduation 118 that is a partial acceptance of the offer for graduation such as, for example, an acceptance at a later date, at a lower credit limit, a partially secured dual-feature payment instrument, or some other such partial acceptance.

In an embodiment, the response 120 to the offer for graduation 118 is used by the graduation determination system 116 to update the machine learning algorithm, the artificial intelligence system, and/or the computational model such as those described herein. For example, a response 120 to the offer for graduation 118 that accepts the offer for graduation may be used to update the machine learning algorithm, the artificial intelligence system, and/or the computational model. In such an example, a response 120 to the offer for graduation 118 that accepts the offer for graduation may be used as an indication that the machine learning algorithm, the artificial intelligence system, and/or the computational model made a correct determination as to whether the secured dual-feature payment instrument should be graduated to an unsecured dual-feature payment instrument and processing of the graduation of the secured dual-feature payment instrument to an unsecured dual-feature payment instrument should be started. Conversely, a response 120 to the offer for graduation 118 that rejects the offer for graduation may be used to update the machine learning algorithm, the artificial intelligence system, and/or the computational model. In such an example, a response 120 to the offer for graduation 118 that rejects the offer for graduation may be used as an indication that the machine learning algorithm, the artificial intelligence system, and/or the computational model made an incorrect determination as to whether the secured dual-feature payment instrument should be graduated to an unsecured dual-feature payment instrument and processing of the graduation of the secured dual-feature payment instrument to an unsecured dual-feature payment instrument should be started. As may be contemplated, a response 120 to the offer for graduation 118 that either accepts, rejects, or partially accepts the offer for graduation may be used to update aspects of the machine learning algorithm, the artificial intelligence system, and/or the computational model. Similarly, other aspects of the response 120 to the offer for graduation 118 (e.g., the amount of time, comments made by the account holder 102, etc.) may be used to update aspects of the machine learning algorithm, the artificial intelligence system, and/or the computational model.

In an embodiment, when the account holder 102 provides a response 120 to the offer for graduation 118 that is an acceptance of the offer for graduation, a graduation system 122 processes the acceptance of the offer for graduation and completes the graduation of the secured dual-feature payment instrument to an unsecured dual-feature payment instrument. The systems and methods that the graduation system 122 uses to graduate a secured dual-feature payment instrument to an unsecured dual-feature payment instrument are described in more detail herein below. In an embodiment, and as illustrated in FIG. 1, the graduation system 122 is an element of the dual-feature payment instrument service 108. In an embodiment, the graduation system 122 is separate from the dual-feature payment instrument service 108. In an embodiment, and as illustrated in FIG. 1, the graduation system 122 is a separate system from the graduation determination system 116 described herein. In an embodiment the graduation system 122 is the same system as the graduation determination system 116 described herein.

In an embodiment, the account holder 102 provides a response 120 to the offer for graduation 118 that is a partial acceptance of the offer for graduation (e.g., the account holder 102 accepts some of the terms of the offer for graduation such as the credit limit but rejects other terms of the offer for graduation such as the interest rate). In such an embodiment, the graduation system 122 may process the partial acceptance of the offer for graduation and may complete one or more of the processes described herein to complete a partial graduation of the secured dual-feature payment instrument to an unsecured dual-feature payment instrument (e.g., in response to the partial acceptance of the offer). For example, the graduation system 122 may establish an unsecured dual-feature payment instrument at a different interest rate than the one included with the offer for graduation 118 that is more acceptable to the account holder 102. In another example, the graduation system 122 may convert the secured dual-feature payment instrument 114 to another secured dual-feature payment instrument with a different deposit amount that is determined using the systems and methods described herein as a result of the partial acceptance of the offer for graduation. As may be contemplated, such partial acceptances of the offer for graduation may be used to update the machine learning algorithms, the artificial intelligence systems and/or the computational models of the graduation determination system 116, as described herein.

In an embodiment, the graduation system 122 is implemented as a service such as the service 1512 described herein at least in connection with FIG. 15. In an embodiment, the graduation system 122 is implemented as a service provided by a merchant such as the merchants described herein at least in connection with FIG. 15. In an embodiment, the graduation system 122 is implemented as a service provided by a computing resources provider such as the computing resource provide 1528 described herein at least in connection with FIG. 15 (e.g., a service such as service 1530 and/or service 1532, both described herein at least in connection with FIG. 15). In an embodiment, the graduation system 122 is implemented as a service such as the payment instrument service 1538 described herein at least in connection with FIG. 15. In some embodiments, the graduation system 122 is implemented as a service operated by the issuer of the secured dual-feature payment instrument and/or the unsecured dual-feature payment instrument. In some embodiments, the graduation system 122 is implemented as a service operated by a third-party on behalf of the issuer of the secured dual-feature payment instrument and/or the unsecured dual-feature payment instrument.

In an embodiment, the graduation system 122 utilizes a machine learning algorithm or an artificial intelligence system to perform the graduation of a secured dual-feature payment instrument to an unsecured dual-feature payment instrument. For example, the graduation system 122 may implement a clustering algorithm to identify similar accounts, account holders, and/or secured dual-feature payment instruments based on one or more vectors as described above (e.g., spending habits, credit limits, payment performance, demographic information, credit scores, changes in credit scores, etc.). In some instances, a dataset of characteristics of accounts, account holders, and/or secured dual-feature payment instruments may be analyzed using a clustering algorithm to how to perform the graduation of a secured dual-feature payment instrument to an unsecured dual-feature payment instrument. Example clustering algorithms may be trained using the collected dataset. In an embodiment, clustering algorithms are trained using sample datasets of characteristics of accounts, account holders, and/or secured dual-feature payment instruments to classify accounts, account holders, and/or secured dual-feature payment instruments in order to determine how secured dual-feature payment instruments should be graduated to unsecured dual-feature payment instruments. Based on the output of the machine learning algorithm built from an individual account, account holder, and/or secured dual-feature payment instrument, a determination of how a secured dual-feature payment instrument should be graduated to an unsecured dual-feature payment instrument.

In an embodiment, the graduation system 122, the dual-feature payment instrument service 108, or another service of the dual-feature payment instrument service 108 generates a computational model and associates the computational model with the account, the account holder, and/or the secured dual-feature payment instrument. In an embodiment, the computational model (not illustrated in FIG. 1) is an algorithmic representation of an account profile that is used by the graduation system 122 to make determinations as to how a secured dual-feature payment instrument should be graduated to an unsecured dual-feature payment instrument. As described herein, the determinations as to how a secured dual-feature payment instrument should be graduated to an unsecured dual-feature payment instrument may be based on spending habits of the account holder, credit limits of the account, payment performance on the account, demographic information of the account holder, credit scores (i.e., reported by a credit reporting service), changes in credit scores or spending habits, proposed terms of the unsecured dual-feature payment instrument, and/or other such information. In an embodiment, the graduation system 122 uses the computational model in conjunction with the machine learning algorithm and/or the artificial intelligence system described herein.

In an embodiment, the computational model is dynamically and continuously updated by the graduation system 122 during the existence of the account associated with the account holder and/or the dual-feature payment instrument (secured or unsecured). In this instance, the computational model is a model that is associated with the account, the account holder, and/or the dual-feature payment instrument. In an embodiment, the computational model is updated through interactions with the dual-feature payment instrument service 108 (e.g., spending transactions, changes to credit scores, changes in spending habits, etc.).

As described above, a computational model is used to solve complex systems such as how a secured dual-feature payment instrument should be graduated to an unsecured dual-feature payment instrument. In simple systems, such determinations might be analytically solved. However, in complex systems such as those described herein, such determinations as to how a secured dual-feature payment instrument should be graduated to an unsecured dual-feature payment instrument may not be easily solved. Such systems may be complex and nonlinear and, accordingly, an analytical solution may not readily apparent. A computational model is used in such systems to generate a solution and/or prediction when an analytical solution may not be available, as described herein.

In an embodiment, the computational model is updated by evaluating predictions (e.g., predictions as to how a secured dual-feature payment instrument should be graduated to an unsecured dual-feature payment instrument) and using that evaluation to further tune the computational model. For example, graduation of a secured dual-feature payment instrument to an unsecured dual-feature payment instrument may be modeled and the computational model may model a likely positive outcome of the graduation. A simulation of that graduation (based either on real or hypothetical data) may then be used to evaluate the efficacy of the modelled prediction of the likely positive outcome of the graduation. The evaluation of the efficacy of the modelled prediction may then be used to update the computational model. Similarly, actual data from other graduations of other secured dual-feature payment instruments and for other accounts may also be used to update the computational model. Determinations about the applicability of information obtained from other accounts, other account holders, and/or other dual-feature payment instruments (secured or unsecured) may be made using machine learning algorithms and/or artificial intelligence techniques such as those described herein.

In an embodiment, the graduation system 122 provides an unsecured dual-feature payment instrument 124 to the account holder 102. In an embodiment, the issuer of the secured dual-feature payment instrument 114 is the same as the issuer of the unsecured dual-feature payment instrument 124 (e.g., the dual-feature payment instrument service 108 or some other such service such as those described herein). In an embodiment, the issuer of the secured dual-feature payment instrument 114 is different than the issuer of the unsecured dual-feature payment instrument 124, so that, for example, the secured dual-feature payment instrument 114 is issued by a first entity (e.g., the dual-feature payment instrument service 108) and the unsecured dual-feature payment instrument 124 is issued by a second entity (e.g., a payment instrument service such as the payment instrument service 1538 described herein at least in connection with FIG. 15 or a merchant such as the merchants also described herein at least in connection with FIG. 15).

In an embodiment, the dual-feature payment instrument service 108 provides a physical unsecured dual-feature payment instrument 124 to the account holder 102 (e.g., by mailing a physical card to the account holder 102). In an embodiment, the dual-feature payment instrument service 108 provides a virtual unsecured dual-feature payment instrument 124 to the account holder 102 by, for example, establishing an account for the account holder 102 using a payment instrument service such as the payment instrument service 1538 described herein at least in connection with FIG. 15. In an embodiment, the dual-feature payment instrument service 108 provides a virtual unsecured dual-feature payment instrument 124 using, for example, a virtual wallet, to the account holder 102 by, for example, establishing an account for the account holder 102 using a service provided by a merchant such as the merchant described herein at least in connection with FIG. 15. In an embodiment, the dual-feature payment instrument service 108 provides a virtual unsecured dual-feature payment instrument 124 to the account holder 102 by, for example, establishing an account for the account holder 102 using a service provided by a computing resources provider such as the computing resources provider 1528 described herein at least in connection with FIG. 15 (e.g., the service 1530 and/or the service 1532 also described herein at least in connection with FIG. 15). In an embodiment, the unsecured dual-feature payment instrument 124 is the same as the secured dual-feature payment instrument 114 described herein. In such an embodiment, the graduation system 122 may convert the secured dual-feature payment instrument 114 to an unsecured dual-feature payment instrument 124 instead of providing a new unsecured dual-feature payment instrument 124 to replace the secured dual-feature payment instrument 114.

In an embodiment, the graduation system 122 sends a request 126 to the deposit service 112 to return the escrowed deposit 134 held in escrow by the deposit service 112 as described herein. In an embodiment, the escrowed deposit is released from escrow and the released deposit 128 is returned 130 to the graduation system 122. In an embodiment, the escrowed deposit 134 is released from escrow and the released deposit 128 is returned 130 to the graduation system 122 automatically (i.e., without the request 126 to the deposit service 112 to return the escrowed deposit 134). In such an embodiment, the release of the escrowed deposit 134 may be automatically triggered by, for example, the issuing of the unsecured dual-feature payment instrument 124 to the account holder 102.

The graduation system 122 may then determine how to process the released deposit 128 that is returned 130 to the graduation system 122. In an embodiment, the graduation system 122 sends 132 all of the released deposit to the account holder 102. In an embodiment, the graduation system 122 subtracts any amount remaining on the secured dual-feature payment instrument 114 from the deposit and the graduation system 122 sends 132 the balance of the released deposit to the account holder 102. In an embodiment, the graduation system 122 (optionally) subtracts any amount remaining on the secured dual-feature payment instrument 114 from the deposit and then sends 132 the balance of the released deposit to the account holder 102 by issuing a credit to the account associated with the unsecured dual-feature payment instrument 124. In an embodiment, the graduation system 122 sends 132 the balance of the released deposit to the account holder 102 by mailing a physical check to the account holder 102. In an embodiment, the graduation system 122 sends 132 the balance of the released deposit to the account holder 102 by issuing a gift card to, for example, a merchant such as the merchants described herein at least in connection with FIG. 15. In an embodiment, the graduation system 122 does not receive the released deposit 128. In such an embodiment, the deposit service 112 may send the released deposit directly to the account holder using one of the methods described herein (e.g., an account credit, a gift card, a check, etc.). In an embodiment, the graduation system 122 does not send a request 126 to the deposit service 112 to return the escrowed deposit 134 held in escrow by the deposit service 112. In such an embodiment, the deposit may be retained in escrow to be used for a new secured dual-feature payment instrument or for some other function associated with accounts of the account holder 102.

In an embodiment, the operations to graduate a secured dual-feature payment instrument 114 to an unsecured dual-feature payment instrument 124 described herein are used by the graduation system 122 to update the machine learning algorithm, the artificial intelligence system, and/or the computational model described herein. For example, when the graduation system 122 (optionally) subtracts any amount remaining on the secured dual-feature payment instrument 114 from the deposit and then sends 132 the balance of the released deposit to the account holder 102 by issuing a credit to the account associated with the unsecured dual-feature payment instrument 124, that operation may be used to update the machine learning algorithm, the artificial intelligence system, and/or the computational model as described herein. In such an example, the operation to return the deposit may be used as an indication that the machine learning algorithm, the artificial intelligence system, and/or the computational model made a correct determination as to how the secured dual-feature payment instrument 114 should be graduated to an unsecured dual-feature payment instrument 124. Conversely, in an example where the amount remaining on the secured dual-feature payment instrument 114 is equal to, or greater than the deposit amount may be used as an indication that the machine learning algorithm, the artificial intelligence system, and/or the computational model made an incorrect determination as to how the secured dual-feature payment instrument 114 should be graduated to an unsecured dual-feature payment instrument 124. As may be contemplated, the example where the amount remaining on the secured dual-feature payment instrument 114 is equal to, or greater than the deposit amount may also be used as an indication that the machine learning algorithm, the artificial intelligence system, and/or the computational model made an incorrect determination as to whether the secured dual-feature payment instrument should be graduated to an unsecured dual-feature payment instrument and processing of the graduation of the secured dual-feature payment instrument to an unsecured dual-feature payment instrument should be started (e.g., the determination made by the graduation determination system 116). Similarly, a response 120 to the offer for graduation 118 that either accepts, rejects, or partially accepts the offer for graduation may be used to update aspects of the machine learning algorithm, the artificial intelligence system, and/or the computational model used by the graduation system 122 to determine how to graduate the secured dual-feature payment instrument 114 to the unsecured dual-feature payment instrument 124. Similarly, other aspects of the processes described herein may be used to update aspects of the machine learning algorithm, the artificial intelligence system, and/or the computational model used by the graduation system 122 to determine how to graduate the secured dual-feature payment instrument 114 to the unsecured dual-feature payment instrument 124.

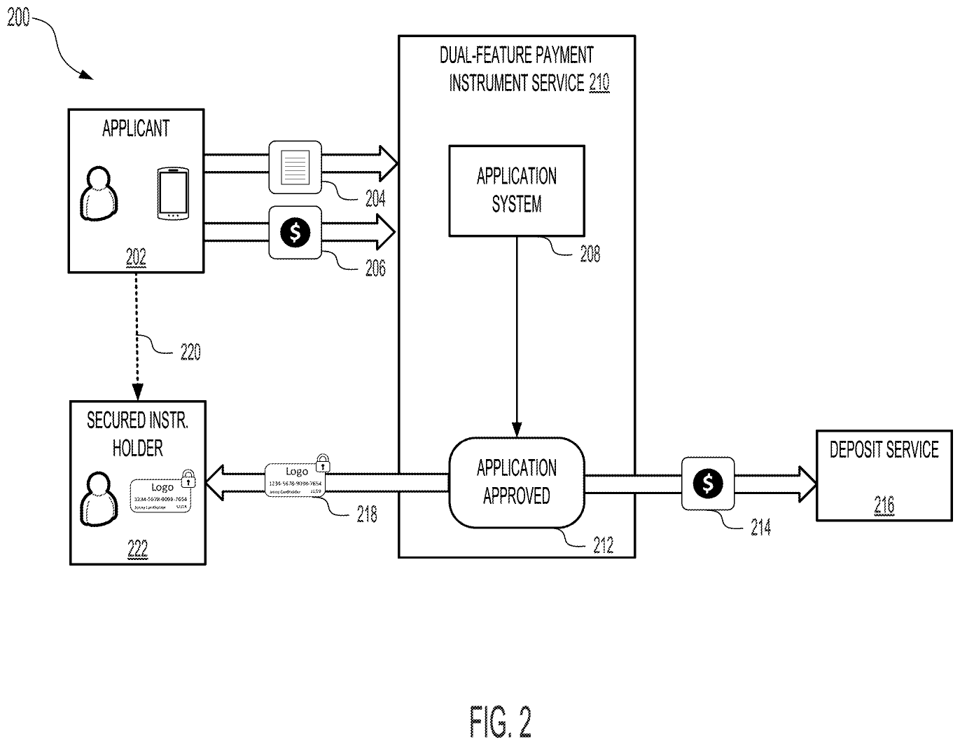

FIG. 2 shows an illustrative example of an environment 200 in which an application for a secured dual-feature payment instrument is processed in accordance with at least one embodiment. In an embodiment, an applicant 202 submits a secured dual-feature payment instrument application 204 to a dual-feature payment instrument service 210 (which is the same as the dual-feature payment instrument service 108 described herein at least in connection with FIG. 1) for a secured dual-feature payment instrument. In an embodiment, the applicant 202 is the same as the account holder 102 described herein at least in connection with FIG. 1). In an embodiment, the applicant 202 provides a security deposit 206 (which is the same as the security deposit 106 described herein at least in connection with FIG. 1) to the dual-feature payment instrument service 210. In an embodiment, the security deposit 206 is provided to the dual-feature payment instrument service 210 with the secured dual-feature payment instrument application 204 (i.e., at the same time that the secured dual-feature payment instrument application is submitted). In an embodiment, the security deposit 206 is provided in response to a request by the dual-feature payment instrument service 210 for the security deposit after the secured dual-feature payment instrument application 204 is received by the dual-feature payment instrument service 210. In an embodiment, the security deposit 206 is provided in response to a request by the dual-feature payment instrument service 210 for the security deposit after the secured dual-feature payment instrument application 204 is processed by the dual-feature payment instrument service 210. In an embodiment, the security deposit 206 is provided in response to a request by the dual-feature payment instrument service 210 for the security deposit after the secured dual-feature payment instrument application 204 is approved by the dual-feature payment instrument service 210 as described herein.

In an embodiment, the applicant 202 uses a computing device such as the computing device 104 described herein at least in connection with FIG. 1 (e.g., a laptop computer, desktop computer, smart phone, etc.) to submit the secured dual-feature payment instrument application 204 to the dual-feature payment instrument service 210 and to provide the security deposit 206 to the dual-feature payment instrument service 210. As described above, in an embodiment, the computing device is a computing device such as the computing device 1502 described herein at least in connection with FIG. 15, or a merchant computing device such as the merchant computing device 1536 described herein at least in connection with FIG. 15, or a virtual computing device that is hosted by a service of a computing resources provider such as the computing resource provider 1528 described herein at least in connection with FIG. 15. In an embodiment, the applicant 202 submits the secured dual-feature payment instrument application 204 and provides the security deposit 206 to the dual-feature payment instrument service 210 using an application running on a device such as the device 104 described herein at least in connection with FIG. 1. In an embodiment, the application is provided by the dual-feature payment instrument service 210. In another embodiment, the application is accessed using a web page or a web portal provided by the dual-feature payment instrument service 210. In an embodiment, the application used by the applicant 202 to submit the secured dual-feature payment instrument application 204 and the application used by the applicant 202 to provide the security deposit 206 are the same application. In an embodiment, the application used by the applicant 202 to submit the secured dual-feature payment instrument application 204 and the application used by the applicant 202 to provide the security deposit 206 are different applications.

In an embodiment, the secured dual-feature payment instrument application 204 is received and processed by an application system 208. In an embodiment, the application system 208 is a system that determines whether a secured dual-feature payment instrument application 204 should be approved. The systems and methods that the application system 208 uses to determine whether a secured dual-feature payment instrument application 204 should be approved may be based on factors including, but not limited to, a credit rating of the applicant 202, an income of the applicant 202, demographics of the applicant 202, the credit amount requested in the secured dual-feature payment instrument application 204, and so on. In an embodiment, and as illustrated in FIG. 2, the application system 208 is an element of the dual-feature payment instrument service 210. In an embodiment, the application system 208 is separate from the dual-feature payment instrument service 210. In an embodiment, the application system 208 is implemented as a service such as the service 1512 described herein at least in connection with FIG. 15. In an embodiment, the application system 208 is implemented as a service provided by a merchant such as the merchants described herein at least in connection with FIG. 15. In an embodiment, the application system 208 is implemented as a service provided by a computing resources provider such as the computing resource provide 1528 described herein at least in connection with FIG. 15 (e.g., a service such as service 1530 and/or service 1532, both described herein at least in connection with FIG. 15). In some embodiments, the application system 208 is implemented as a service operated by the issuer of the secured dual-feature payment instrument and/or an issuer of an unsecured dual-feature payment instrument. In some embodiments, the application system 208 is implemented as a service operated by a third-party on behalf of the issuer of the secured dual-feature payment instrument and/or an issuer of an unsecured dual-feature payment instrument.

In an embodiment, the application system 208 utilizes a machine learning algorithm, an artificial intelligence system, and/or a computational model to determine whether a secured dual-feature payment instrument application 204 should be approved, using systems and methods such as those described herein. For example, the application system 208 may implement a machine learning clustering algorithm to identify similar applicants based on one or more vectors (e.g., spending habits, credit limits, payment performance, demographic information, credit scores, changes in credit scores, etc.) as described herein. In an embodiment, the application system 208, the dual-feature payment instrument service 210, or another service of the dual-feature payment instrument service 210 generates a computational model and associates the computational model with the secured dual-feature payment instrument application 204 of the applicant 202 using systems and methods such as those described herein. For example, the application system 208, the dual-feature payment instrument service 210, or another service of the dual-feature payment instrument service 210 may generate a computational model of the account or the applicant 202 and use that computational model to determine whether a secured dual-feature payment instrument application 204 should be approved. In an embodiment, the computational model is dynamically and continuously updated by the application system 208 during (and after) the application process based on, for example, predictions as to the likelihood of the approval of one or more secured dual-feature payment instrument applications. As may be contemplated, other computational models associated with the dual-feature payment instrument service 210 (e.g., those used by the graduation determination system 116, those used by the graduation system 122 (both described herein at least in connection with FIG. 1), and/or other such systems and services) may also be updated based upon the operations of the application system 208 to approve or deny a secured dual-feature payment instrument application 204.

In an embodiment, if the application system 208 determines that the secured dual-feature payment instrument application 204 is approved 212, the dual-feature payment instrument service 210 provides 214 the deposit to a deposit service 216 as described above (i.e., where the dual-feature payment instrument service 108 provides 110 the deposit to the deposit service 112, all as described herein at least in connection with FIG. 1). Similarly, and in an embodiment, if the application system 208 determines that the secured dual-feature payment instrument application 204 is approved 212 and when the security deposit 206 is received, the dual-feature payment instrument service 210 provides a secured dual-feature payment instrument 218 to the applicant 202, who becomes 220 a secured card holder 222 (i.e., the applicant 202 is the same entity as the secured card holder 222, but with a change in status from an applicant to a secured card holder). Accordingly, as used herein, a secured card holder 222 is the same as an account holder (e.g., the account holder 102 described herein at least in connection with FIG. 1) wherein the account holder has a secured dual-feature payment instrument. That is, a secured card holder 222 is an account holder 102 that has received the secured dual-feature payment instrument 114 as described herein at least in connection with FIG. 1. As described herein, the dual-feature payment instrument service 210 may provide a physical secured dual-feature payment instrument 218 to the secured card holder 222 or may provide a virtual secured dual-feature payment instrument 218 to the secured card holder 222 using one of the methods described herein.

In some embodiments, the application system 208 can determine that the secured dual-feature payment instrument application 204 should not be approved. In such embodiments, the dual-feature payment instrument service 210 may return any deposit such as the security deposit 206 to the applicant 202 using one or more of the methods described herein at least in connection with FIG. 1. In such embodiments, the machine learning algorithm, artificial intelligence system, and/or the computational model used by the application system 208 may be updated based on the determination that the secured dual-feature payment instrument application 204 should not be approved.

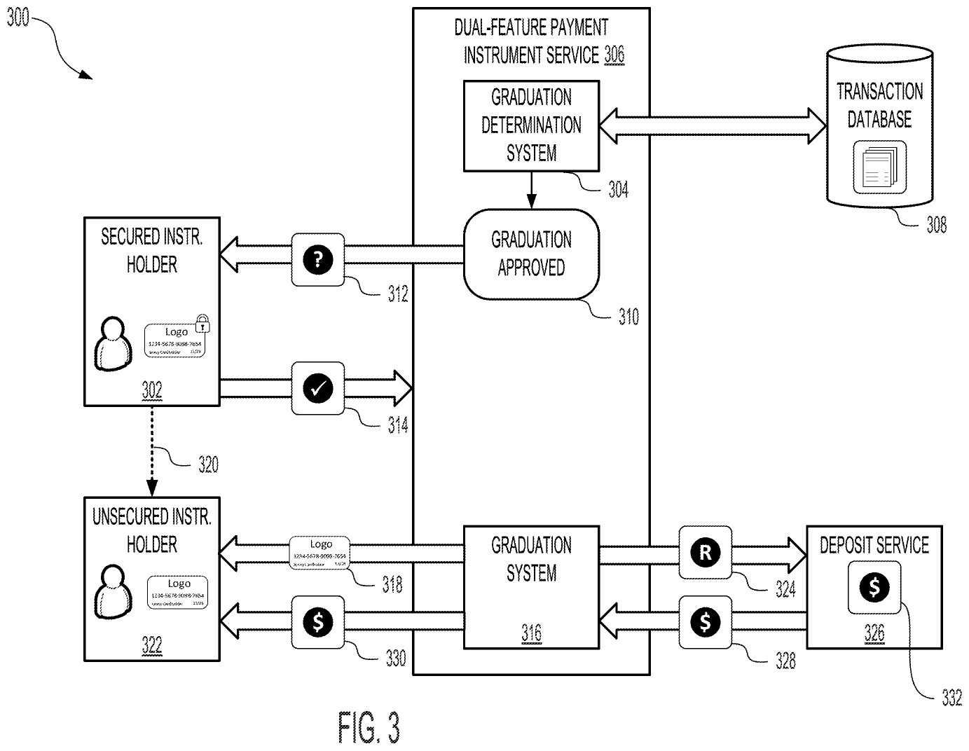

FIG. 3 shows an illustrative example of an environment 300 in which an offer of graduation of a secured dual-feature payment instrument to an unsecured dual-feature payment instrument is accepted by an account holder in accordance with at least one embodiment. In an embodiment, a graduation determination system 304 (which is the same as the graduation determination system 116 described herein at least in connection with FIG. 1) of a dual-feature payment instrument service 306 (which is the same as the dual-feature payment instrument service 108 described herein at least in connection with FIG. 1) monitors transactions in a transaction database 308 to determine whether a secured dual-feature payment instrument of a secured card holder 302 (which is the same as the secured card holder 222 described herein at least in connection with FIG. 2) should be graduated to an unsecured dual-feature payment instrument using systems and methods such as those described herein.

In an embodiment, the transaction database 308 is an organized collection of transaction data that may be stored using a storage device such as the storage device 1510 described herein at least in connection with FIG. 15 and accessed using a computing device (e.g., the computing device 1502, the computing device 1524, the merchant computing device 1536, and/or one or more computing devices and/or virtual computing devices associated with a computing resources provider 1528, all of which are described herein at least in connection with FIG. 15). A transaction database 308 may be organized with fields and records so that, for example, the data stored in the transaction database 308 may be easily organized, accessed, stored, retrieved, sorted, and queried, among other operations.

In an embodiment, the transaction database 308 is organized as a relational database, wherein the transaction data is organized in tables, using rows and columns, with relationship values used to provide a correlation between the records (or rows) in the various tables. A relational database may be accessed using a structured query language (“SQL”), a data query language (“DQL”), a data definition language (“DDL”), a data control language (“DCL”), a data manipulation language (“DML”), or a variant of one or more of these. An SQL database may have good performance (e.g., for accessing the data in the database), but that performance typically comes at the expense of scalability as any change to the data structure of the records (e.g., to add or remove a data field) may require a complete refactorization of the database. A relational database may also provide a great deal of consistency in that, when a database operation is completed, the data stored in the database is in a consistent and predictable state.

In an embodiment, the transaction database 308 is organized as a non-relational database, wherein the transaction data is organized in a less structured manner, with individual records having widely varying structures and relationship models. Such non-relational data may be stored using extended markup language (“XML”) and accessed using XML document attributes. A non-relational database may be referred to as a “NoSQL” database and such databases may be accessed using any of a vast number of query languages. A NoSQL database may provide a great deal of scalability due to the less structured storage of the data, but that scalability typically comes at the expense of performance. A non-relational database may provide what is referred to as “eventual” consistency in that, when a database operation is completed, the data stored in the database may not be in a consistent and predictable state until some future time.

In an embodiment, the transaction database 308 is organized as a hybrid of a relational database and a non-relational database called a NewSQL database, wherein the transaction data may be stored in a less structured manner akin to that of a NoSQL database, but the transactional data may also include relational elements. Such NewSQL databases may provide the scalability of non-relational databases with the performance and consistency guarantees of a relational database.

In an embodiment, the transaction database 308 stores data records of payment instrument transactions. In an embodiment, the data records of payment instrument transactions include data records of transactions associated with the secured dual-feature payment instrument of the secured card holder 302. Such transactions may include purchase transactions made with the secured dual-feature payment instrument of the secured card holder 302. Such transactions may also include payment transactions associated with an account of the secured card holder 302 associated with the secured dual-feature payment instrument. Such payment transactions may include a payment history of the secured card holder 302 (e.g., the date and amount of payments on the account, whether the payments were late or early, whether the payments were the minimum amount, whether the payments were for the entire balance, how long any outstanding balance was kept on the account, and so on).

In an embodiment, if the graduation determination system 304 determines that the graduation of the secured dual-feature payment instrument of the secured card holder 302 should be graduated to an unsecured dual-feature payment instrument and/or that the processing of the graduation of the secured dual-feature payment instrument to an unsecured dual-feature payment instrument should be started and the graduation is approved 310, the graduation determination system 304 communicates an offer of graduation 312 to the secured card holder 302 using methods such as those described herein (e.g., using an application running on a device associated with the secured card holder 302).

In an embodiment, if the secured card holder 302 provides a response 314 to the offer of graduation 312 that is an acceptance of the offer (i.e., that the secured card holder agrees to graduate the secured dual-feature payment instrument to an unsecured dual-feature payment instrument) the dual-feature payment instrument service 306 starts the graduation of the secured dual-feature payment instrument to an unsecured dual-feature payment instrument using systems and methods such as those described herein. For example, the dual-feature payment instrument service 306 may use a graduation system 316 (which is the same as the graduation system 122 described herein at least in connection with FIG. 1) to provide an unsecured dual-feature payment instrument 318 to the secured card holder 302, whereupon the secured card holder 302 becomes 320 an unsecured card holder 322 (i.e., the secured card holder 302 is the same entity as the unsecured card holder 322, but with a change in status from a secured card holder to an unsecured card holder). Accordingly, as used herein, an unsecured card holder 322 is the same as an account holder (e.g., the account holder 102 described herein at least in connection with FIG. 1) wherein the account holder has an unsecured dual-feature payment instrument. That is, an unsecured card holder 322 is an account holder 102 that has received the unsecured dual-feature payment instrument 124 as described herein at least in connection with FIG. 1. As described herein, the dual-feature payment instrument service 306 may provide a physical unsecured dual-feature payment instrument 318 to the unsecured card holder 322, or may provide a virtual unsecured dual-feature payment instrument 318 to the unsecured card holder 322, or may convert the secured dual-feature payment instrument to an unsecured dual-feature payment instrument as described herein.

In an embodiment, if the secured card holder 302 provides a response 314 to the offer of graduation 312 that is an acceptance of the offer (i.e., that the secured card holder agrees to graduate the secured dual-feature payment instrument to an unsecured dual-feature payment instrument) the dual-feature payment instrument service 306 may also use the graduation system 316 to send a request 324 to a deposit service 326 to return the escrowed deposit 332 and the released deposit is returned 328 to the graduation system 316 (which is the same as when the graduation system 122 sends a request 126 to the deposit service 112 to return the escrowed deposit 134 and the released deposit 128 is returned 130 to the graduation system 122 described herein at least in connection with FIG. 1). In an embodiment, the escrowed deposit 332 is released from escrow and the released deposit is returned 328 to the graduation system 316 using systems and methods such as those described herein. In an embodiment, the graduation system 316 then determines how to process the released deposit that is returned 328 to the graduation system 316 also using systems and methods such as those described herein (e.g., by sending the deposit to the unsecured card holder 322, crediting some or all of the deposit to an account associated with the unsecured dual-feature payment instrument, issuing a gift card, etc.). As may be contemplated, the secured card holder 302 may provide a response 314 to the offer of graduation 312 that is a rejection of the offer of graduation or that is a partial acceptance of the offer of graduation, both as described herein.

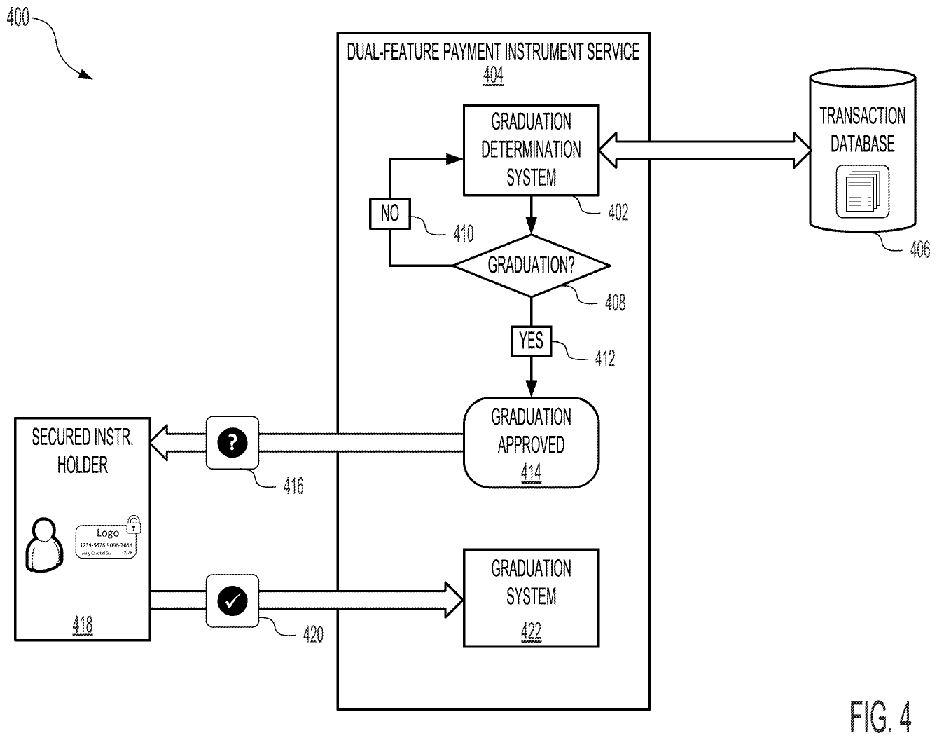

FIG. 4 shows an illustrative example of an environment 400 in which a secured dual-feature payment instrument is monitored to determine whether an offer of graduation should be presented in accordance with at least one embodiment. In an embodiment, a graduation determination system 402 (which is the same as the graduation determination system 116 described herein at least in connection with FIG. 1) of a dual-feature payment instrument service 404 (which is the same as the dual-feature payment instrument service 108 described herein at least in connection with FIG. 1) monitors transactions in a transaction database 406 (which is the same as the transaction database 308 described herein at least in connection with FIG. 3) to determine whether a secured dual-feature payment instrument of a secured card holder 418 (which is the same as the secured card holder 222 described herein at least in connection with FIG. 2) should be graduated to an unsecured dual-feature payment instrument.

As described above and in an embodiment, the transaction database 406 stores records of transactions of an account associated with the secured card holder 418 and the secured dual-feature payment instrument of the secured card holder 418. Such transactions may include purchase transactions, payment transactions, a payment history, and other such transaction records. In an embodiment, the graduation determination system 402 determines 408 whether the secured dual-feature payment instrument should be graduated to an unsecured dual-feature payment instrument by monitoring the transactions in the transaction database 406 and evaluating those transactions against one or more rules implemented by the dual-feature payment instrument service 404 and/or the graduation determination system 402. In an embodiment, the graduation determination system continuously monitors the transactions in the transaction database 406 and evaluates those transactions using one or more rules implemented by the dual-feature payment instrument service 404 and/or the graduation determination system 402. In an embodiment, the graduation determination system periodically monitors the transactions in the transaction database 406 and evaluates those transactions using one or more rules implemented by the dual-feature payment instrument service 404 and/or the graduation determination system 402. In an embodiment, the graduation determination system 402 monitors the transactions in the transaction database 406 and evaluates those transactions using one or more rules implemented by the dual-feature payment instrument service 404 and/or the graduation determination system 402 using one or more of a machine learning algorithm, an artificial intelligence system, or a computational model as described herein.

In an embodiment, if the graduation determination system 402 determines 408 that the secured dual-feature payment instrument should not be graduated 410 (i.e., the “NO” branch), the graduation determination system 402 returns to the continuous or periodic monitoring of the transactions in the transaction database 406 and evaluation of those transactions using one or more rules implemented by the dual-feature payment instrument service 404 and/or the graduation determination system 402. In an embodiment, if the graduation determination system 402 determines 408 that the secured dual-feature payment instrument should be graduated 412 (i.e., the “YES” branch) to an unsecured dual-feature payment instrument and/or that the processing of the graduation of the secured dual-feature payment instrument to an unsecured dual-feature payment instrument should be started, the graduation is approved 414. In an embodiment, the graduation determination system 402 communicates an offer of graduation 416 to the secured card holder 418 using methods such as those described herein (e.g., using an application running on a device associated with the secured card holder 418).

In an embodiment, if the secured card holder 418 provides a response 420 that is an acceptance of the offer of graduation 416 (i.e., that the secured card holder agrees to graduate the secured dual-feature payment instrument to an unsecured dual-feature payment instrument), a rejection of the offer of graduation 416 (i.e., that the secured card holder declines to graduate the secured dual-feature payment instrument to an unsecured dual-feature payment instrument), or a partial acceptance of the offer of graduation 416 (i.e., that the secured card holder agrees to graduate the secured dual-feature payment instrument to an unsecured dual-feature payment instrument under certain conditions), the dual-feature payment instrument service 404 directs the graduation system 422 to complete the graduation of the secured dual-feature payment instrument to an unsecured dual-feature payment instrument using systems and methods such as those described herein.

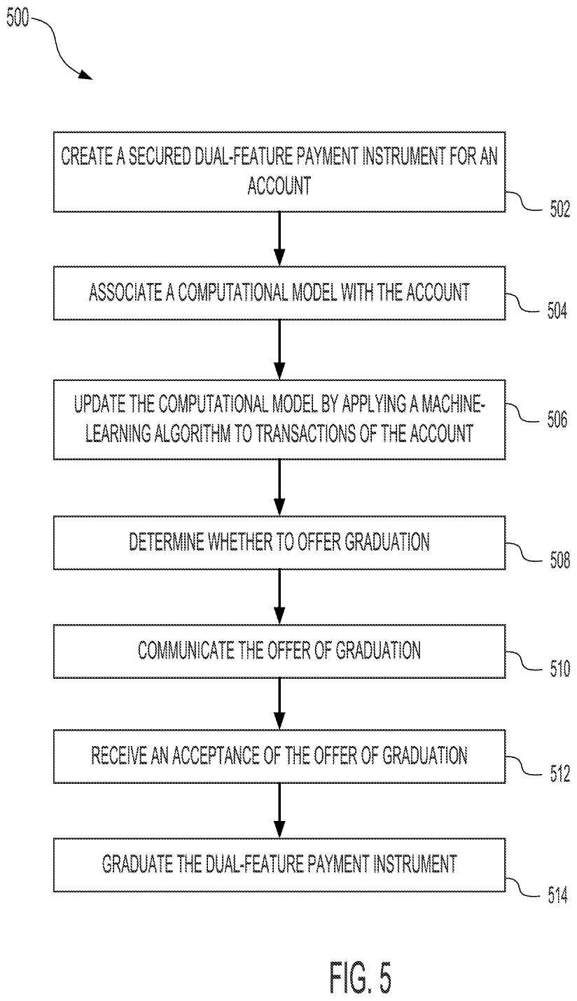

FIG. 5 shows an illustrative example of a process 500 in which an offer of graduation of a secured dual-feature payment instrument to an unsecured dual-feature payment instrument is presented to an account holder in accordance with at least one embodiment. Various systems of a dual-feature payment instrument service such as the dual-feature payment instrument service 108 described herein at least in connection with FIG. 1 may perform the example process 500 illustrated in FIG. 5.

At step 502 of the example process 500, systems of a dual-feature payment instrument service create a secured dual-feature payment instrument for an account. In an embodiment, systems of the dual-feature payment instrument service create the secured dual-feature payment instrument and associate the secured dual-feature payment instrument with an existing account of an account holder such as the account holder 102 described herein at least in connection with FIG. 1. In an embodiment, systems of the dual-feature payment instrument service create a new account associated with the account holder (e.g., the account holder 102 described herein at least in connection with FIG. 1), create the secured dual-feature payment instrument, and associate the secured dual-feature payment instrument with that new account.

At step 504 of the example process 500, systems of a dual-feature payment instrument service associate a computational model with the account. In an embodiment, systems of a dual-feature payment instrument service associate an existing computational model with the account. In an embodiment, systems of a dual-feature payment instrument service create a new computational model and associate the new computational model with the account. As described above, a computational model is an algorithmic representation of an account profile that is used by systems of a dual-feature payment instrument service (e.g., the graduation determination system 116 described herein at least in connection with FIG. 1) to make determinations as to whether a secured dual-feature payment instrument should be graduated to an unsecured dual-feature payment instrument and/or to trigger the processing of the graduation of the secured dual-feature payment instrument to an unsecured dual-feature payment instrument. In an embodiment, the determinations as to whether a secured dual-feature payment instrument should be graduated to an unsecured dual-feature payment instrument and/or to trigger the processing of the graduation of the secured dual-feature payment instrument to an unsecured dual-feature payment instrument may be based on spending habits of the account holder, credit limits of the account, payment performance on the account, demographic information of the account holder, credit scores (i.e., reported by a credit reporting service), changes in credit scores or spending habits, and/or other such information. In an embodiment, systems of a dual-feature payment instrument service (e.g., the graduation determination system 116 described herein at least in connection with FIG. 1) use the computational model in conjunction with machine learning algorithms and/or artificial intelligence system such as those described herein.

At step 506 of the example process 500, systems of a dual-feature payment instrument service update the computational model by applying a machine-learning algorithm to transactions associated with the account. As described above, systems of a dual-feature payment instrument service update the computational model by applying a machine-learning algorithm to transactions associated with the account. In an embodiment, the computational model is dynamically and continuously updated by systems of a dual-feature payment instrument service (e.g., the graduation determination system 116 described herein at least in connection with FIG. 1) during the existence of the account associated with the account holder and/or the dual-feature payment instrument (secured or unsecured). In an embodiment, a computational model (such as the computational models described herein) is implemented as one or more computer algorithms that may be executed on computer systems (e.g., computer systems of the dual-feature payment instrument service) to model a particular system. In an embodiment, the computational model is a model that is associated with the account, the account holder, and/or the dual-feature payment instrument. In an embodiment, the computational model is updated through interactions with systems of the dual-feature payment instrument service (e.g., spending transactions, changes to credit scores, changes in spending habits, etc.).

In an embodiment, at step 506 of the example process 500, the computational model is updated by evaluating predictions (e.g., predictions as to whether a secured dual-feature payment instrument should be graduated to an unsecured dual-feature payment instrument and/or to trigger the processing of the graduation of the secured dual-feature payment instrument to an unsecured dual-feature payment instrument) and using that evaluation to further tune the computational model. For example, graduation of a secured dual-feature payment instrument to an unsecured dual-feature payment instrument may be modeled and the computational model may model a likely positive outcome of the graduation. A simulation of that graduation (based either on real or hypothetical data) may then be used to evaluate the efficacy of the modelled prediction of the likely positive outcome of the graduation. The evaluation of the efficacy of the modelled prediction may then be used to update the computational model. Similarly, actual data from other graduations of other secured dual-feature payment instruments and for other accounts may also be used to update the computational model. Determinations about the applicability of information obtained from other accounts, other account holders, and/or other dual-feature payment instruments (secured or unsecured) may be made using machine learning algorithms and/or artificial intelligence techniques such as those described herein.

At step 508 of the example process 500, systems of a dual-feature payment instrument service determine whether to offer graduation of the secured dual-feature payment instrument associated with the account to an unsecured dual-feature payment instrument using systems and methods such as those described herein. In an embodiment, a graduation determination system (e.g., the graduation determination system 116 described herein at least in connection with FIG. 1) determines whether the secured dual-feature payment instrument should be graduated to an unsecured dual-feature payment instrument by monitoring transactions in a transaction database (e.g., the transaction database 308 described herein at least in connection with FIG. 3) and evaluates those transactions against one or more rules implemented by a dual-feature payment instrument service (e.g., the dual-feature payment instrument service 108 described herein at least in connection with FIG. 1) and/or the graduation determination system.

At step 510 of the example process 500, systems of a dual-feature payment instrument service communicate the offer of graduation of the secured dual-feature payment instrument associated with the account to an unsecured dual-feature payment instrument using systems and methods such as those described herein and at step 512 of the example process 500, systems of a dual-feature payment instrument service receive an acceptance of the offer of graduation of the secured dual-feature payment instrument associated with the account to an unsecured dual-feature payment instrument also using systems and methods such as those described herein.

At step 514 of the example process 500, systems of a dual-feature payment instrument service graduate the secured dual-feature payment instrument associated with the account to an unsecured dual-feature payment instrument. In an embodiment, a graduation system (e.g., the graduation system 122 described herein at least in connection with FIG. 1) performs the operations to graduate the secured dual-feature payment instrument associated with the account to an unsecured dual-feature payment instrument by, for example, requesting the return of the escrowed deposit from a deposit service (e.g., the deposit service 112 described herein at least in connection with FIG. 1), issuing the unsecured dual-feature payment instrument, and returning some or all of the escrowed deposit to the unsecured dual-feature payment instrument holder (e.g., the unsecured card holder 322 described herein at least in connection with FIG. 3).

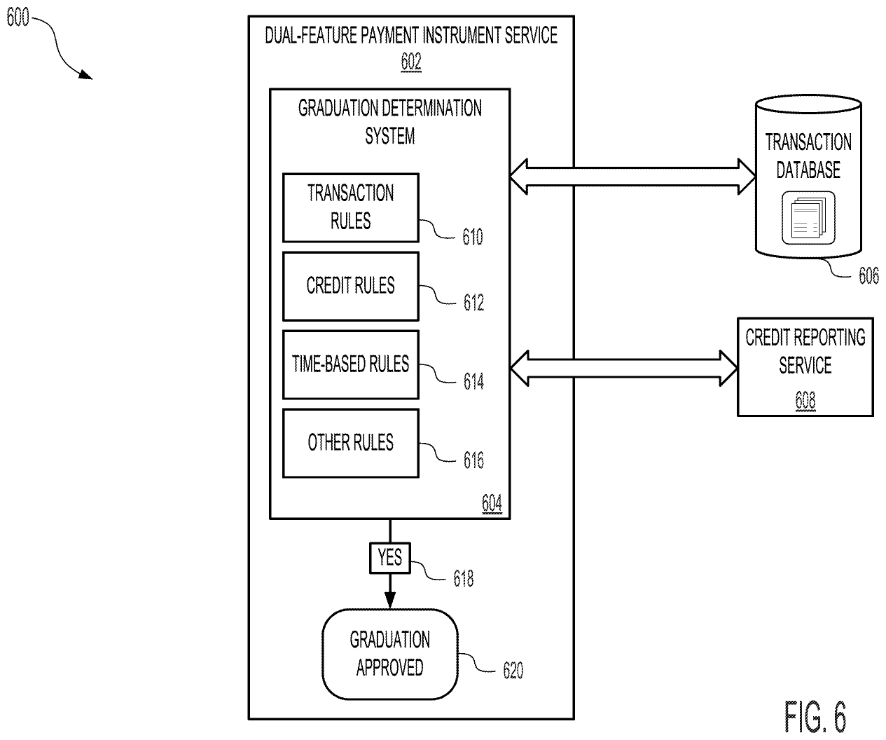

FIG. 6 shows an illustrative example of an environment 600 in which a graduation determination system determines whether to graduate a secured dual-feature payment instrument to an unsecured dual-feature payment instrument in accordance with at least one embodiment. In an embodiment, a graduation determination system 604 (which is the same as the graduation determination system 116 described herein at least in connection with FIG. 1) of a dual-feature payment instrument service 602 (which is the same as the dual-feature payment instrument service 108 described herein at least in connection with FIG. 1) determines whether to graduate a secured dual-feature payment instrument to an unsecured dual-feature payment instrument using systems as methods such as those described herein. In an embodiment, the graduation determination system 604 evaluates data associated with a secured dual-feature payment instrument using a series of rules to determine whether to graduate a secured dual-feature payment instrument to an unsecured dual-feature payment instrument.

In an embodiment, the graduation determination system 604 evaluates data from a transaction database 606 (which is the same as the transaction database 308 described herein at least in connection with FIG. 3) using a set of transaction rules 610 to determine whether to graduate a secured dual-feature payment instrument to an unsecured dual-feature payment instrument. For example, the dual-feature payment instrument service 602 and/or the graduation determination system 604 may establish a transaction rule that the account holder of the secured dual-feature payment instrument must have a minimum number of transactions per month. In another example, the dual-feature payment instrument service 602 and/or the graduation determination system 604 may establish a transaction rule that the account holder of the secured dual-feature payment instrument may not exceed a maximum number of transactions per month. In another example, the dual-feature payment instrument service 602 and/or the graduation determination system 604 may establish a transaction rule that the account holder of the secured dual-feature payment instrument may not make a late payment on the account associated with the secured dual-feature payment instrument. In another example, the dual-feature payment instrument service 602 and/or the graduation determination system 604 may establish a transaction rule that the account holder of the secured dual-feature payment instrument may not have a maximum balance more than a certain percentage of the time. As may be contemplated, these transaction rules are merely illustrative examples of the types of transaction rules 610 that are used by the graduation determination system 604 to determine whether to graduate a secured dual-feature payment instrument to an unsecured dual-feature payment instrument and other such transaction rules may be considered as within the scope of the present disclosure.

In an embodiment, the graduation determination system 604 evaluates data from a credit reporting service 608 using a set of credit rules 612 to determine whether to graduate a secured dual-feature payment instrument to an unsecured dual-feature payment instrument. A used herein, a credit reporting service 608 is a service that computes and/or provides a credit score for the account holder of the secured dual-feature payment instrument (e.g., a FICO™ score, Vantage™ score, CE™ score, or some other such credit score). In an embodiment, the credit reporting service 608 is a service such as the service 1512 described herein at least in connection with FIG. 15. In an embodiment, the credit reporting service 608 is a service provided by a merchant such as the merchants described herein at least in connection with FIG. 15. In an embodiment, the credit reporting service 608 is a service provided by a computing resources provider such as the computing resource provide 1528 described herein at least in connection with FIG. 15 (e.g., a service such as service 1530 and/or service 1532 described herein at least in connection with FIG. 15). In an embodiment, the credit reporting service 608 operates in conjunction with a payment instrument service such as the payment instrument service 1538 described herein at least in connection with FIG. 15. In some embodiments, the credit reporting service 608 is a service operated by the issuer of the secured dual-feature payment instrument and/or the unsecured dual-feature payment instrument. In some embodiments, the credit reporting service 608 is a service operated by a third-party on behalf of the issuer of the secured dual-feature payment instrument and/or the unsecured dual-feature payment instrument.

In an example, the dual-feature payment instrument service 602 and/or the graduation determination system 604 may establish a credit rule that the account holder of the secured dual-feature payment instrument must have a minimum FICO™ score. In another example, the dual-feature payment instrument service 602 and/or the graduation determination system 604 may establish a credit rule that the account holder of the secured dual-feature payment instrument must maintain that minimum FICO™ score for some consecutive number of months. In another example, the dual-feature payment instrument service 602 and/or the graduation determination system 604 may establish a credit rule that the account holder of the secured dual-feature payment instrument must have a reporting history for a minimum number or months. As may be contemplated, these rules are merely illustrative examples of the types of credit rules 612 that are used by the graduation determination system 604 to determine whether to graduate a secured dual-feature payment instrument to an unsecured dual-feature payment instrument and other such credit rules may be considered as within the scope of the present disclosure.

In an embodiment, the graduation determination system 604 uses a set of time-based rules 614 to determine whether to graduate a secured dual-feature payment instrument to an unsecured dual-feature payment instrument. For example, the dual-feature payment instrument service 602 and/or the graduation determination system 604 may establish a time-based rule that the account holder of the secured dual-feature payment instrument must keep the account associated with the secured dual-feature payment instrument open for a minimum number of months. In another example, the dual-feature payment instrument service 602 and/or the graduation determination system 604 may establish a time-based rule that the account holder of the secured dual-feature payment instrument must have lived at their present address for a minimum number of months. As may be contemplated, these rules are merely illustrative examples of the types of time-based rules 614 that are used by the graduation determination system 604 to determine whether to graduate a secured dual-feature payment instrument to an unsecured dual-feature payment instrument and other such time-based rules may be considered as within the scope of the present disclosure.

In an embodiment, the graduation determination system 604 uses a set of other rules 616 to determine whether to graduate a secured dual-feature payment instrument to an unsecured dual-feature payment instrument. For example, the dual-feature payment instrument service 602 and/or the graduation determination system 604 may establish rules that are based on demographics of the account holder of the secured dual-feature payment instrument (e.g., the age of the account holder). In another example, the dual-feature payment instrument service 602 and/or the graduation determination system 604 may establish a rule that a certain percentage of transactions associated with the secured dual-feature payment instrument must be made with a certain merchant. In an embodiment, one or more of the other rules 616 are established by a merchant such as the merchants described herein at least in connection with FIG. 15, or established by a credit-card service such as the payment instrument service 1538 described herein at least in connection with FIG. 15, or established by a third party. As may be contemplated, these rules are merely illustrative examples of the types of other rules 616 that are used by the graduation determination system 604 to determine whether to graduate a secured dual-feature payment instrument to an unsecured dual-feature payment instrument and other such rules may be considered as within the scope of the present disclosure.

In an embodiment, the time-based rules 614 are used as a set of “gateway” rules in that the graduation determination system 604 uses the set of time-based rules 614 to make the initial determination of whether to graduate a secured dual-feature payment instrument to an unsecured dual-feature payment instrument and then proceeds to the other rules (e.g., the transaction rules 610 and/or the credit rules 612) only if the gateway rules are satisfied. In another embodiment, the set of transaction rules 610 are used as the set of gateway rules and are evaluated first. In another embodiment, the set of credit rules 612 are used as the set of gateway rules and are evaluated first. In another embodiment, the set of other rules 616 are used as the set of gateway rules and are evaluated first.

In an embodiment, the graduation determination system 604 uses the set of rules (e.g., the transaction rules 610, the credit rules 612, the time-based rules 614, and/or the other rules 616) to determine whether to graduate a secured dual-feature payment instrument to an unsecured dual-feature payment instrument using a machine learning algorithm, an artificial intelligence system, and/or a computational model such as those described herein. In an embodiment, if the graduation determination system 604 determines 618 that the graduation is approved 620 (i.e., the “YES” branch), the dual-feature payment instrument service 602 may process the graduation of the secured dual-feature payment instrument to an unsecured dual-feature payment instrument using systems and methods such as those described herein.

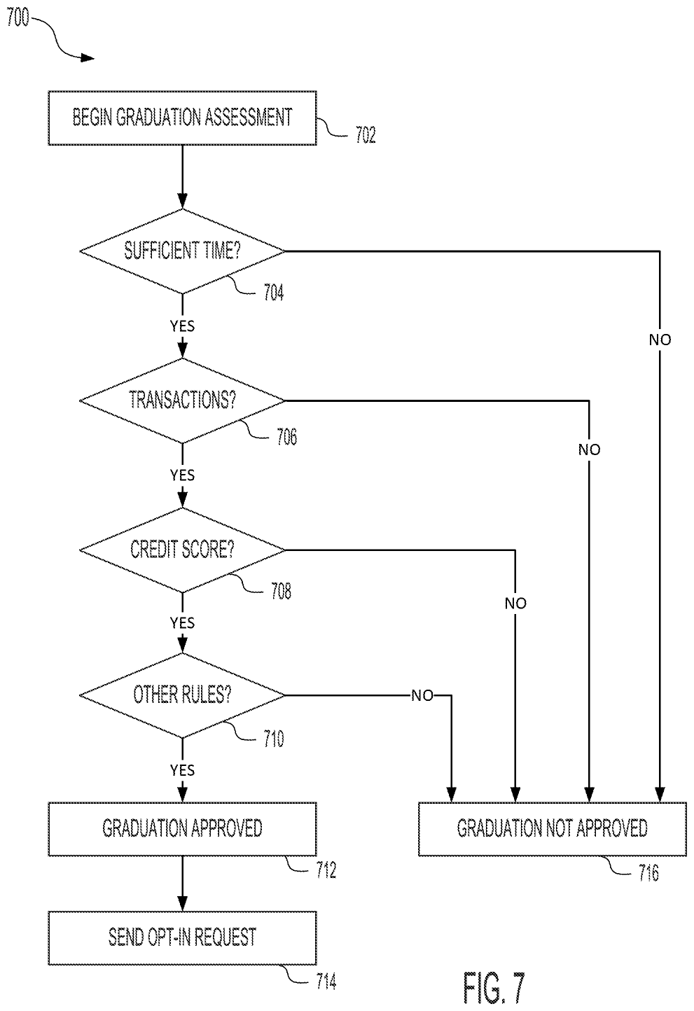

FIG. 7 shows an illustrative example of a process 700 in which a graduation determination system determines whether to graduate a secured dual-feature payment instrument to an unsecured dual-feature payment instrument in accordance with at least one embodiment. Various systems of a dual-feature payment instrument service such as the dual-feature payment instrument service 108 described herein at least in connection with FIG. 1 may perform the example process 700 illustrated in FIG. 7.

At step 702 of the example process 700, systems of a dual-feature payment instrument service begin a graduation assessment of a secured dual-feature payment instrument using, for example, a graduation determination system such as the graduation determination system 116 described herein at least in connection with FIG. 1.

At step 704 of the example process 700, systems of a dual-feature payment instrument service determine whether sufficient time has passed since the creation of the secured dual-feature payment instrument. The determination at step 704 of whether sufficient time has passed since the creation of the secured dual-feature payment instrument is an example of using a time-based rule such as the time-based rules 614 described herein at least in connection with FIG. 6. The determination at step 704 of whether sufficient time has passed since the creation of the secured dual-feature payment instrument is also an example of applying gateway rule, as described herein at least in connection with FIG. 6.

If at step 704, systems of the dual-feature payment instrument service determine that sufficient time has not passed since the creation of the secured dual-feature payment instrument (“NO” branch), the example process continues at step 716, described in detail below.

If at step 704, systems of the dual-feature payment instrument service determine that sufficient time has passed since the creation of the secured dual-feature payment instrument (“YES” branch), at step 706 of the example process 700, systems of a dual-feature payment instrument service examine transactions associated with the secured dual-feature payment instrument to determine whether those transactions support graduation of the secured dual-feature payment instrument to an unsecured dual-feature payment instrument. The determination at step 706 of whether transactions associated with the secured dual-feature payment instrument support graduation of the secured dual-feature payment instrument to an unsecured dual-feature payment instrument is an example of using a transaction rule such as the transaction rules 610 described herein at least in connection with FIG. 6.

If at step 706, systems of the dual-feature payment instrument service determine that the transactions associated with the secured dual-feature payment instrument do not support graduation of the secured dual-feature payment instrument to an unsecured dual-feature payment instrument (“NO” branch), the example process continues at step 716, described in detail below.

If at step 706, systems of the dual-feature payment instrument service determine that the transactions associated with the secured dual-feature payment instrument do support graduation of the secured dual-feature payment instrument to an unsecured dual-feature payment instrument (“YES” branch), at step 708 of the example process 700, systems of a dual-feature payment instrument service determine whether a credit score of an account associated with the secured dual-feature payment instrument is sufficient to support graduation of the secured dual-feature payment instrument to an unsecured dual-feature payment instrument. The determination at step 708 of whether a credit score of an account associated with the secured dual-feature payment instrument is sufficient to support graduation of the secured dual-feature payment instrument to an unsecured dual-feature payment instrument is an example of using a credit rule such as the credit rules 612 described herein at least in connection with FIG. 6.

If at step 708, systems of the dual-feature payment instrument service determine that a credit score of an account associated with the secured dual-feature payment instrument is not sufficient to support graduation of the secured dual-feature payment instrument to an unsecured dual-feature payment instrument (“NO” branch), the example process continues at step 716, described in detail below.

If at step 708, systems of the dual-feature payment instrument service determine that a credit score of an account associated with the secured dual-feature payment instrument is sufficient to support graduation of the secured dual-feature payment instrument to an unsecured dual-feature payment instrument (“YES” branch), at step 710 of the example process 700, systems of a dual-feature payment instrument service determine whether to support graduation of the secured dual-feature payment instrument to an unsecured dual-feature payment instrument using one or more other rules such as the other rules 616 described herein at least in connection with FIG. 6.

If at step 710, systems of the dual-feature payment instrument service determine not to support graduation of the secured dual-feature payment instrument to an unsecured dual-feature payment instrument using one or more other rules (“NO” branch), the example process continues at step 716, described in detail below.

If at step 710, systems of the dual-feature payment instrument service determine to support graduation of the secured dual-feature payment instrument to an unsecured dual-feature payment instrument using one or more other rules (“YES” branch), at step 712 of the example process 700, systems of a dual-feature payment instrument service approve the graduation of the secured dual-feature payment instrument to an unsecured dual-feature payment instrument and at step 714 of the example process 700, systems of the dual-feature payment instrument service start the graduation by sending an opt-in request to an account associated with the secured dual-feature payment instrument (e.g., the opt-in request described herein at least in connection with FIG. 1).

At step 716 of the example process 700, systems of a dual-feature payment instrument service do not approve the graduation of the secured dual-feature payment instrument to an unsecured dual-feature payment instrument. Regardless of whether the example process 700 reaches step 716 via step 704, via step 706, via step 708, or via 710, systems of a dual-feature payment instrument service may do nothing and continue evaluating the account of the secured dual-feature payment instrument using systems and methods such as those described herein or may perform actions such as terminating the account associated with the secured dual-feature payment instrument, flagging the account associated with the secured dual-feature payment instrument for additional evaluation, or perform some other such action.

It should be noted that, although not illustrated in FIG. 7, the example process 700 is re-entrant. That is, in an embodiment, systems of a dual-feature payment instrument service may periodically restart the example process 700 at step 702. Similarly, in an embodiment, systems of a dual-feature payment instrument service may continually restart the example process 700 at step 702 after reaching step 716. It should also be noted that the example process 700 may be performed in parallel for a plurality of secured dual-feature payment instruments associated with one or more accounts and/or account holders.

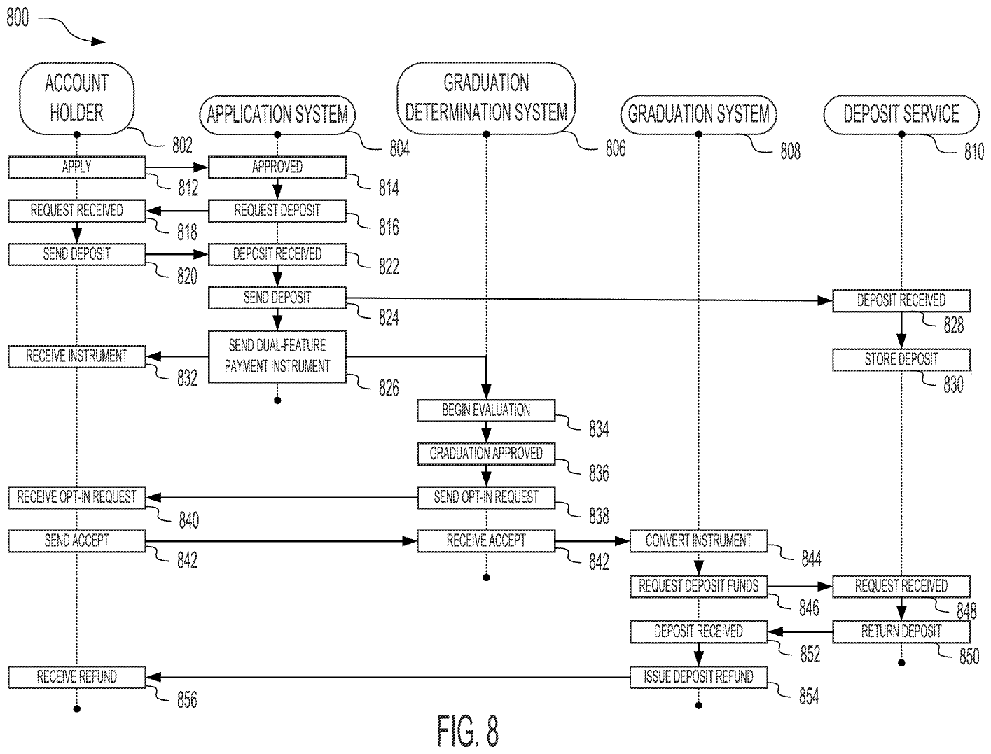

FIG. 8 shows an illustrative example of an environment 800 in which the data flow for an offer of graduation of a secured dual-feature payment instrument to an unsecured dual-feature payment instrument is presented to an account holder in accordance with at least one embodiment. In an embodiment, an account holder 802 (which is the same as the account holder 102 described herein at least in connection with FIG. 1) applies 812 for a secured dual-feature payment instrument by sending an application to an application system 804 (which is the same as the application system 208 described herein at least in connection with FIG. 2). In an embodiment, if the application is approved 814 by the application system 804, the application system 804 requests a deposit 816 from the account holder 802. In an embodiment, when the request for the deposit is received 818 by the account holder 802, the account holder can then send the deposit 820 to the application system 804. Although not illustrated in FIG. 8, in an embodiment, when the request for the deposit is received 818 by the account holder 802, the account holder can opt to not send the deposit to the application system 804. In such an embodiment, the data flow illustrated in example environment 800 may terminate without any further operations.

In an embodiment, when the deposit is received 822 by the application system 804, the application system 804 sends the deposit 824 to a deposit service 810 (which is the same as the deposit service 112 described herein at least in connection with FIG. 1). In an embodiment, when the deposit service 810 receives the deposit 828, the deposit service 810 stores the deposit 830 as described herein. In an embodiment, when the deposit is received 822 by the application system 804, the application system 804 sends the dual-feature payment instrument 826 (e.g., a secured dual-feature payment instrument) to the account holder 802 and the account holder 802 receives the secured dual-feature payment instrument as described herein.

In an embodiment, at some point after the application system 804 sends the secured dual-feature payment instrument 826 to the account holder 802 and the account holder 802 begins to use the secured dual-feature payment instrument, a graduation determination system 806 (which is the same as the graduation determination system 116 described herein at least in connection with FIG. 1) begins an evaluation 834 of the account associated with the secured dual-feature payment instrument using systems and methods such as those described herein. At some point after the graduation determination system 806 begins the evaluation 834 of the account associated with the secured dual-feature payment instrument, in an embodiment the graduation determination system 806 determines that the graduation of the secured dual-feature payment instrument to an unsecured dual-feature payment instrument is approved 836.

In an embodiment, when the graduation determination system 806 determines that the graduation of the secured dual-feature payment instrument to an unsecured dual-feature payment instrument is approved 836, the graduation determination system 806 generates and sends an opt-in request 838 to the account holder 802. When the account holder 802 receives the opt-in request 840, in an embodiment the account holder 802 sends an acceptance 842 of the opt-in request to the graduation determination system 806 and the graduation determination system 806 receives the acceptance 842 of the opt-in request. Although not illustrated in FIG. 8, in an embodiment the account holder 802 does not send an acceptance of the opt-in request or sends a partial acceptance of the opt-in request, both of which are described herein. In such an embodiment, the data flow illustrated in example environment 800 may terminate without any further operations or may perform other operations not illustrated in FIG. 8 such as those described herein.

When the graduation determination system 806 receives the acceptance 842 of the opt-in request, in an embodiment the graduation determination system 806 causes a graduation system 808 (which is the same as the graduation system 122 described herein at least in connection with FIG. 1) to begin the processes to convert the secured dual-feature payment instrument to an unsecured dual-feature payment instrument 844. In an embodiment, the graduation system 808 then requests the return of the deposit funds 846 from the deposit service 810. In an embodiment, when the deposit service 810 receives the request for the return of the deposit funds 848 from the graduation system 808, the deposit service 810 performs operations to return the deposit 850 to the graduation system 808.

In an embodiment, when the graduation system 808 receives the deposit 852 from the deposit service 810, the graduation system 808 performs operations to issue a deposit refund 854 to the account holder 802 and the account holder 802 receives the refund of the deposit 856. As may be contemplated, additional operations associated with the data flow for an offer of graduation of a secured dual-feature payment instrument to an unsecured dual-feature payment instrument is presented to an account holder may exist even if not illustrated in FIG. 8. For example, the graduation system 808 may issue an unsecured dual-feature payment instrument to the account holder 802 as described herein. In another example, the graduation system 808 may return a portion of the deposit to the account holder 802 and use the remainder of the deposit to satisfy outstanding obligations of an account associated with the secured dual-feature payment instrument (e.g., the secured dual-feature payment instrument 826 sent to the account holder 802).

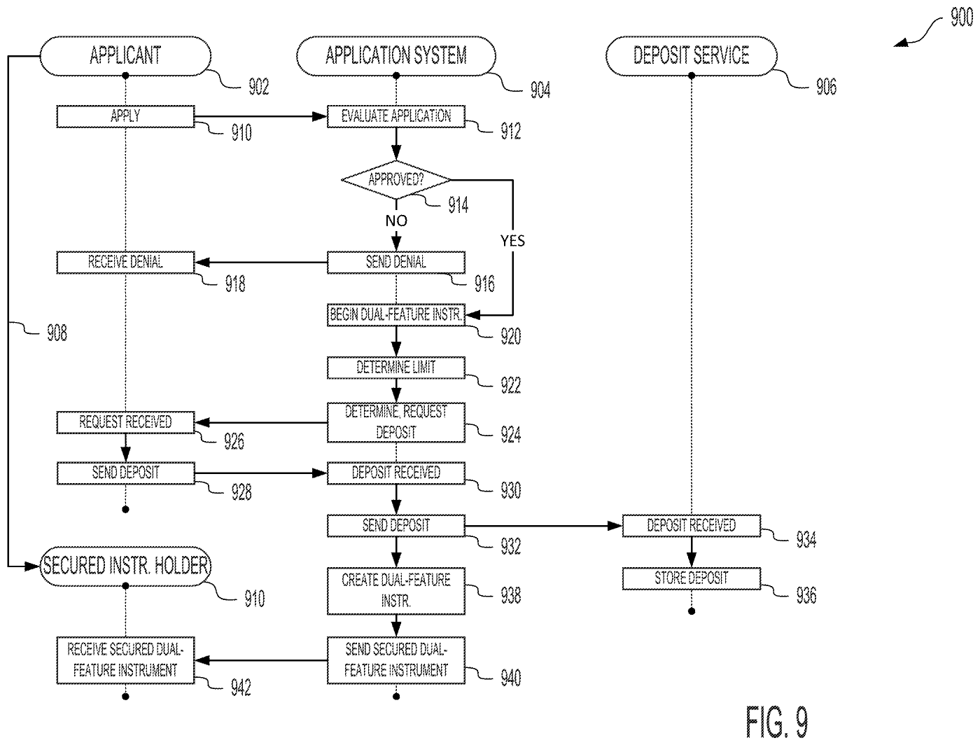

FIG. 9 shows an illustrative example of an environment 900 in which in which the first part of a data flow for the graduation of a secured dual-feature payment instrument to an unsecured dual-feature payment instrument is illustrated in accordance with at least one embodiment. In the example environment 900 illustrated in FIG. 9, the portion of the data flow where an application for a secured dual-feature payment instrument is processed is illustrated. In an embodiment, an applicant 902 (which is the same as the applicant 202 described herein at least in connection with FIG. 2) applies 910 for a secured dual-feature payment instrument by sending an application to an application system 904 (which is the same as the application system 208 described herein at least in connection with FIG. 2). In an embodiment, if the application is not approved 914 by the application system 904 (the “NO” branch), the application system 904 sends a denial 916 to the applicant 902. When the applicant 902 receives the denial 918 of the application for a secured dual-feature payment instrument, the data flow illustrated in example environment 900 may terminate without any further operations.

In an embodiment, if the application is approved 914 by the application system 904 (the “YES” branch), the application system 904 begins the process of creating the secured dual-feature payment instrument 920. In an embodiment, the application system 904 then determines a credit limit 922 for the secured dual-feature payment instrument, determines an appropriate amount for the deposit and sends a request for that deposit 924 to the applicant 902. For example, the application system 904 may determine that the appropriate amount for the deposit is equal to the determined credit limit 922, or may determine that the appropriate amount for the deposit is equal to a fraction of the determined credit limit 922 (e.g., half of the credit limit), or may determine that the appropriate amount for the deposit is equal to a multiple of the determined credit limit 922 (e.g., twice the credit limit).

In an embodiment, when the request for the deposit is received 926 by the applicant 902, the applicant 902 then sends the deposit 928 to the application system 904. Although not illustrated in FIG. 9, in an embodiment, when the request for the deposit is received 926 by the applicant 902, the applicant 902 can opt to not send the deposit to the application system 904. In such an embodiment, the data flow illustrated in example environment 900 may terminate without any further operations.

In an embodiment, when the deposit is received 930 from the applicant 902 by the application system 904, the application system 904 sends the deposit 932 to a deposit service 906 (which is the same as the deposit service 112 described herein at least in connection with FIG. 1). In an embodiment, when the deposit service 906 receives the deposit 934, the deposit service 906 stores the deposit 936 as described herein. In an embodiment, when the deposit is received 930 by the application system 904 and sent to the deposit service, the application system 904 creates a dual-feature card 938 (e.g., a secured dual-feature payment instrument) and sends the dual-feature card 940 (e.g., a secured dual-feature payment instrument). At some point after the application system 904 creates the dual-feature card 938 (e.g., the secured dual-feature payment instrument), the applicant 902 may become denoted 908 as a secured card holder 910. In an embodiment, when the application system 904 creates a dual-feature card 938 (e.g., a secured dual-feature payment instrument) and sends the dual-feature card 940 (e.g., a secured dual-feature payment instrument), the application system 904 sends the sends the dual-feature card 940 to the secured card holder 910, who receives the secured dual-feature payment instrument 942 as described herein.

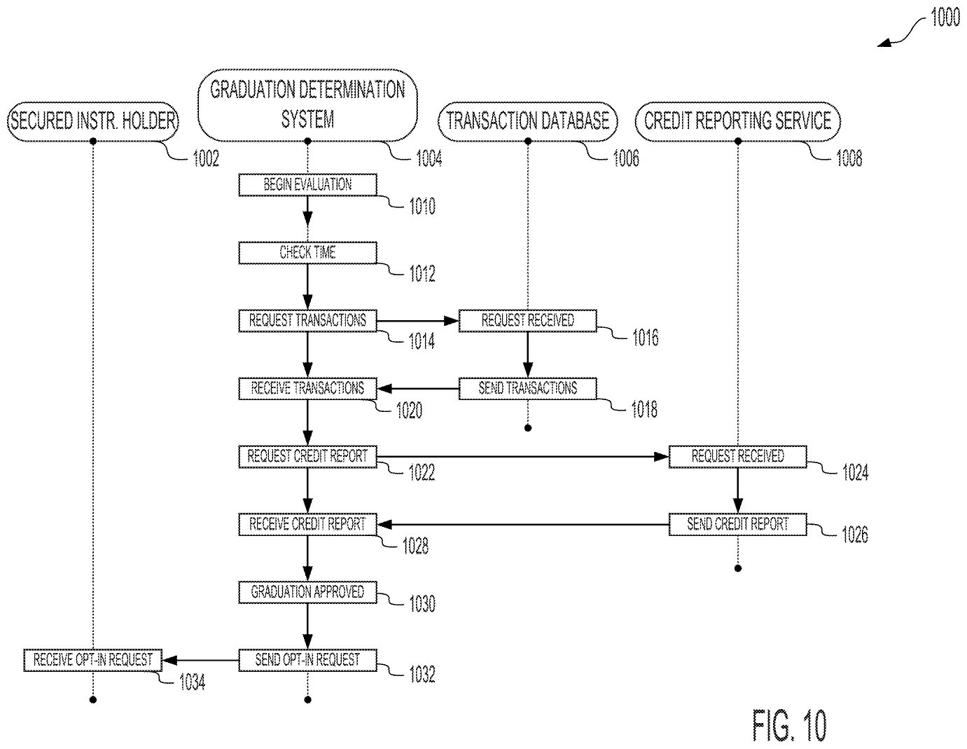

Although not specifically illustrated in FIG. 9, the data flow for the graduation of a secured dual-feature payment instrument to an unsecured dual-feature payment instrument is continued in the example environment 1000 illustrated in FIG. 10.

FIG. 10 shows an illustrative example of an environment 1000 in which the second part of a data flow for the graduation of a secured dual-feature payment instrument to an unsecured dual-feature payment instrument is illustrated in accordance with at least one embodiment. In the example environment 1000 illustrated in FIG. 10, the portion of the data flow where an offer for the graduation of a secured dual-feature payment instrument to an unsecured dual-feature payment instrument is presented to an account holder is illustrated.

In an embodiment, a graduation determination system 1004 (which is the same as the graduation determination system 116 described herein at least in connection with FIG. 1) begins an evaluation 1010 of the account associated with the secured dual-feature payment instrument using systems and methods such as those described herein. At some point after the graduation determination system 1004 begins the evaluation 1010 of the account associated with the secured dual-feature payment instrument, in an embodiment, the graduation determination system 1004 first checks the elapsed time 1012 since the secured dual-feature payment instrument was created (e.g., when the application system 904 created the dual-feature card 938 described herein at least in connection with FIG. 9). Although not illustrated in FIG. 10, the graduation determination system 1004 may use one or more time-based rules (e.g., the time-based rules 614 described herein at least with connection with FIG. 6) to determine if the secured dual-feature payment instrument might be eligible for graduation to an unsecured dual-feature payment instrument.

In an embodiment, the graduation determination system 1004 then sends a request for transactions associated with the secured dual-feature payment instrument 1014 from a transaction database 1006 (which is the same as the transaction database 308 described herein at least in connection with FIG. 3). In an embodiment, when the transaction database 1006 receives the request for transactions associated with the secured dual-feature payment instrument 1016, the transaction database 1006 then sends the transactions associated with the secured dual-feature payment instrument 1018 to the graduation determination system 1004, which receives the transactions associated with the secured dual-feature payment instrument 1020. Although not illustrated in FIG. 10, the graduation determination system 1004 may use one or more transaction rules (e.g., the transaction rules 610 described herein at least with connection with FIG. 6) and the received transactions to determine if the secured dual-feature payment instrument might be eligible for graduation to an unsecured dual-feature payment instrument.

In an embodiment, the graduation determination system 1004 then sends a request for a credit report 1022 for an account holder associated with the secured dual-feature payment instrument (e.g., the secured card holder 1002) from a credit reporting service 1008 (which is the same as the credit reporting service 608 described herein at least in connection with FIG. 6). In an embodiment, when the credit reporting service 1008 receives the request 1024 for a credit report for an account holder associated with the secured dual-feature payment instrument (e.g., the secured card holder 1002), the credit reporting service 1008 then sends the credit report 1026 to the graduation determination system 1004, which receives 1028 the credit report 1022 for an account holder associated with the secured dual-feature payment instrument (e.g., the secured card holder 1002). Although not illustrated in FIG. 10, the graduation determination system 1004 may use one or more credit rules (e.g., the credit rules 612 described herein at least with connection with FIG. 6) and the received credit report to determine if the secured dual-feature payment instrument might be eligible for graduation to an unsecured dual-feature payment instrument. Although not illustrated in FIG. 10, the graduation determination system 1004 may also use one or more other rules (e.g., the other rules 616 described herein at least with connection with FIG. 6) to determine if the secured dual-feature payment instrument might be eligible for graduation to an unsecured dual-feature payment instrument.

In an embodiment, if the graduation determination system 1004 then determines that the graduation of the secured dual-feature payment instrument to an unsecured dual-feature payment instrument is approved 1030, the graduation determination system 1004 generates and sends an opt-in request 1032 to the secured card holder 1002 who then receives the opt-in request 1034.

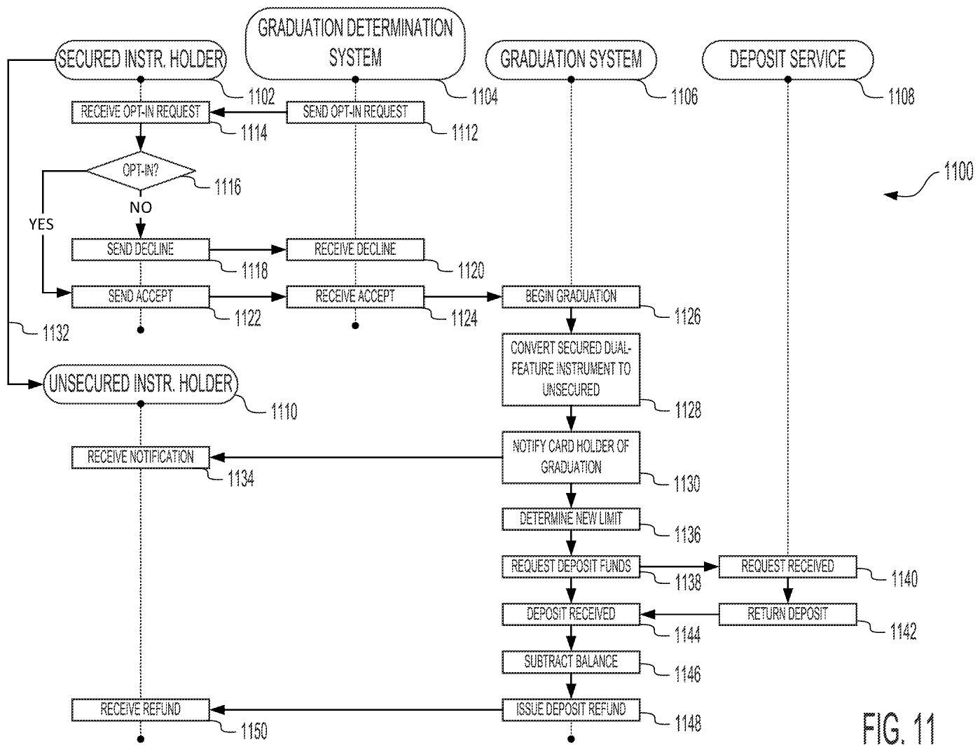

Although not specifically illustrated in FIG. 10, the data flow for the graduation of a secured dual-feature payment instrument to an unsecured dual-feature payment instrument is continued in the example environment 1100 illustrated in FIG. 11.

FIG. 11 shows an illustrative example of an environment 1100 in which the third part of a data flow for the graduation of a secured dual-feature payment instrument to an unsecured dual-feature payment instrument is illustrated in accordance with at least one embodiment. In the example environment 1100 illustrated in FIG. 11, the portion of the data flow where an accepted offer of graduation of a secured dual-feature payment instrument to an unsecured dual-feature payment instrument is processed is illustrated. After the graduation determination system determines that the graduation of the secured dual-feature payment instrument to an unsecured dual-feature payment instrument is approved (as illustrated and described at least in connection with FIG. 10), the graduation determination system 1104 generates and sends an opt-in request 1112 to the secured card holder 1102 who receives the opt-in request 1114. It should be noted that this data flow (e.g., where the graduation determination system 1104 generates and sends an opt-in request 1112 to the secured card holder 1102 and where the secured card holder 1102 receives the opt-in request 1114) is the same as the data flow where the graduation determination system 1004 generates and sends an opt-in request 1032 to the secured card holder 1002 who then receives the opt-in request 1034 as illustrated and described at least in connection with FIG. 10.

In an embodiment, the secured card holder 1102 (which is the same as the secured card holder 222 described herein at least in connection with FIG. 2) then determines 1116 whether to opt-in (i.e., whether to accept the offer for graduation of the secured dual-feature payment instrument to an unsecured dual-feature payment instrument). In an embodiment, if the secured card holder 1102 does not accept the offer for graduation of the secured dual-feature payment instrument to an unsecured dual-feature payment instrument (the “NO” branch where the secured card holder 1102 determines 1116 whether to opt-in), the secured card holder 1102 sends a response that declines 1118 the offer for graduation of the secured dual-feature payment instrument to an unsecured dual-feature payment instrument to the graduation determination system 1104 (which is the same as the graduation determination system 116 described herein at least in connection with FIG. 1). In an embodiment, when the graduation determination system 1104 receives 1120 the decline of the offer for graduation of the secured dual-feature payment instrument to an unsecured dual-feature payment instrument, the data flow illustrated in example environment 1100 may terminate without any further operations.

In an embodiment, if the secured card holder 1102 does accept the offer for graduation of the secured dual-feature payment instrument to an unsecured dual-feature payment instrument (the “YES” branch where the secured card holder 1102 determines 1116 whether to opt-in), the secured card holder 1102 sends a response that accepts 1122 the offer for graduation of the secured dual-feature payment instrument to an unsecured dual-feature payment instrument to the graduation determination system 1104. In an embodiment, when the graduation determination system 1104 receives 1124 the acceptance of the offer for graduation of the secured dual-feature payment instrument to an unsecured dual-feature payment instrument, a graduation system 1106 (which is the same as the graduation system 122 described herein at least in connection with FIG. 1) begins the graduation 1126 of the secured dual-feature payment instrument to an unsecured dual-feature payment instrument.

In an embodiment, the graduation system 1106 converts the secured dual-feature payment instrument to an unsecured dual-feature payment instrument 1128 using systems and methods such as those described herein. In an embodiment, the secured card holder 1102 becomes 1132 an unsecured card holder 1110 (which is the same as the unsecured card holder 322 described herein at least in connection with FIG. 3) when the graduation system 1106 converts the secured dual-feature payment instrument to an unsecured dual-feature payment instrument 1128. In an embodiment, the graduation system 1106 then sends a notice 1130 to the unsecured card holder 1110 that the secured dual-feature payment instrument has been graduated to an unsecured dual-feature payment instrument and the unsecured card holder 1110 receives the notification 1134.

In an embodiment, the graduation system 1106 then determines a new credit limit 1136 for the unsecured dual-feature payment instrument. In an embodiment, the new credit limit 1136 for the unsecured dual-feature payment instrument is the same as the credit limit for the secured dual-feature payment instrument. In an embodiment, the new credit limit 1136 for the unsecured dual-feature payment instrument is greater than or less than the credit limit for the secured dual-feature payment instrument.

In an embodiment, the graduation system 1106 then sends a request 1138 for the security deposit funds associated with the secured dual-feature payment instrument to a deposit service 1108 (which is the same as the deposit service 112 described herein at least in connection with FIG. 1). When the deposit service 1108 receives the request 1140 for the security deposit funds, the deposit service 1108 returns 1142 the security deposit funds to the graduation system 1106. In an embodiment, when the graduation system 1106 receives 1144 the security deposit funds, the graduation system 1106 subtracts 1146 any outstanding balance from the security deposit funds (e.g., a balance remaining on the secured dual-feature payment instrument) and issues a deposit refund 1148 of the remaining funds to the unsecured card holder 1110 who then receives the refund 1150.

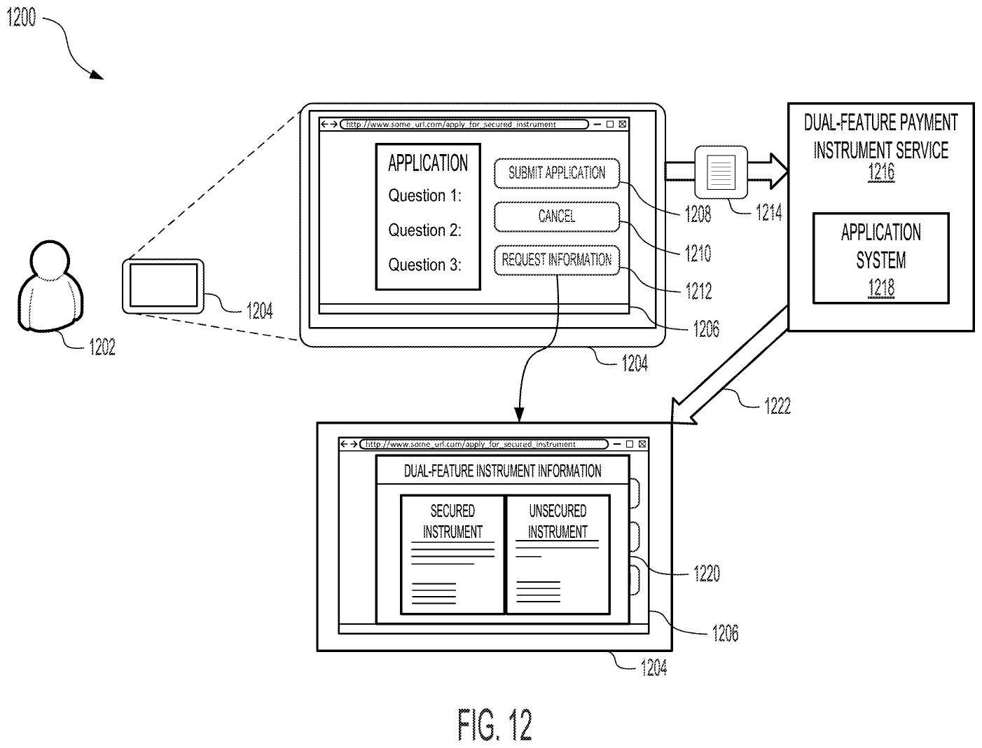

FIG. 12 shows an illustrative example of an environment 1200 in which an application for a secured dual-feature payment instrument is presented in accordance with at least one embodiment. In an embodiment, an applicant 1202 for a secured dual-feature payment instrument (which is the same as the applicant 202 described herein at least in connection with FIG. 2) uses a computing device 1204 to apply for a secured dual-feature payment instrument. In an embodiment, the computing device 1204 (which is the same as the computing device 104 described herein at least in connection with FIG. 1) is a computing device such as the computing device 1502 described herein at least in connection with FIG. 15. In an embodiment, the computing device is a merchant computing device such as the merchant computing device 1536 described herein at least in connection with FIG. 15. In an embodiment, the computing device 104 is a virtual computing device that is hosted by a service of a computing resources provider such as the computing resource provider 1528 described herein at least in connection with FIG. 15 (e.g., the service 1530 and/or the service 1532 described herein at least in connection with FIG. 15).

In an embodiment, the applicant 1202 interacts with systems of a dual-feature payment instrument service 1216 (which is the same as the dual-feature payment instrument service 108 described herein at least in connection with FIG. 1) using an application 1206 running on the device 1204. In an embodiment, the application 1206 running on the device 1204 is an application provided by the dual-feature payment instrument service 1216 that runs on the device 1204. In an embodiment, the application 1206 can be accessed using a web page or a web portal provided by the dual-feature payment instrument service 1216 and the interactions with the dual-feature payment instrument service 1216 are displayed on the device 1204.

In an embodiment, the application 1206 running on the device 1204 displays user interface elements including, but not limited to, icons, text, buttons, dropdown lists, radio buttons, check boxes, and visual canvases to convey information obtained from systems of the dual-feature payment instrument service 1216, obtained from third-parties, and/or obtained from other information sources. In an embodiment, the application 1206 running on the device 1204 uses those user interface elements to obtain information from the account holder (e.g., the applicant 1202 for a secured dual-feature payment instrument), to provide the obtained information to systems of the dual-feature payment instrument service 1216, to third-parties, and/or to other information subscribers.

In an embodiment, the application 1206 running on the device 1204 includes various decorative user interface options such as, for example, a logo. In an embodiment, the logo and/or other decorative user interface elements of the application 1206 running on the device 1204 can be dynamically altered to conform to a merchant's design esthetic. For example, the logo and/or other decorative user interface elements of the application 1206 running on the device 1204 can be updated to display a logo for a manufacturer, a retailer, or a designer associated with a dual-feature payment instrument (secured or unsecured). Such logos and other design elements may be used to attach a “brand” to the application 1206 running on the device 1204. Such logos and other decorative design elements may be obtained from a library of such design elements maintained by the dual-feature payment instrument service 1216.

In an embodiment, the application 1206 running on the device 1204 uses user interface elements to gather information from the applicant 1202 in order to generate an application for a secured dual-feature payment instrument 1214. In an embodiment, the application for a secured dual-feature payment instrument 1214 is received by an application system 1218 (which is the same as the application system 208 described herein at least in connection with FIG. 2) and processed by the application system 1218 using systems and methods such as those described herein.

In an embodiment, the application 1206 running on the device 1204 includes additional user interface elements to perform additional functions. For example, the application 1206 running on the device 1204 may include a button 1208 to submit the application for a secured dual-feature payment instrument 1214. In another example, the application 1206 running on the device 1204 may include a button 1210 to cancel the submission of the application for a secured dual-feature payment instrument. In an embodiment, the application 1206 running on the device 1204 includes a button 1212 to request additional information from the dual-feature payment instrument service 1216. In such an embodiment, the dual-feature payment instrument service 1216 may cause the application 1206 running on the device 1204 to display additional information 1220 for the secured dual-feature payment instrument and/or the unsecured dual-feature payment instrument such as, for example terms and conditions for the secured dual-feature payment instrument and/or the unsecured dual-feature payment instrument. In an embodiment, the dual-feature payment instrument service 1216 can automatically cause the application 1206 running on the device 1204 to display the additional information 1220 for the secured dual-feature payment instrument and/or the unsecured dual-feature payment instrument (e.g., the terms and conditions for the secured dual-feature payment instrument and/or the unsecured dual-feature payment instrument) without the use of the button 1212 to request additional information from the dual-feature payment instrument service 1216.

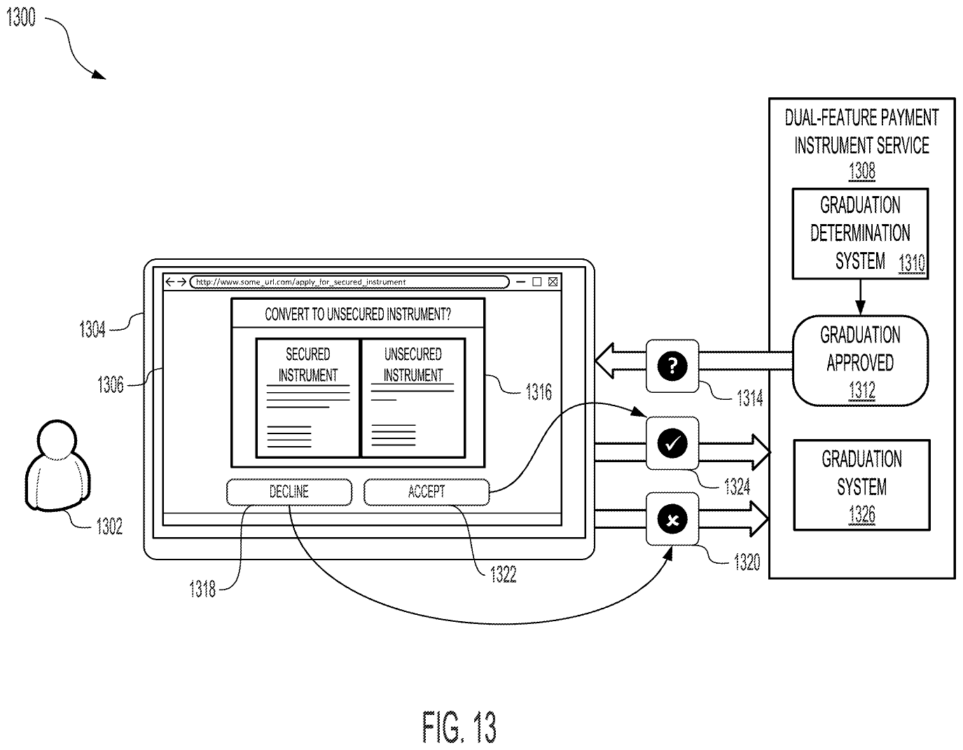

FIG. 13 shows an illustrative example of an environment 1300 in which an offer of graduation of a secured dual-feature payment instrument to an unsecured dual-feature payment instrument is presented in accordance with at least one embodiment. In an embodiment, a secured card holder 1302 (which is the same as the secured card holder 222 described herein at least in connection with FIG. 2) uses a computing device 1204 to interact with systems of a dual-feature payment instrument service 1308 (which is the same as the dual-feature payment instrument service 108 described herein at least in connection with FIG. 1). In an embodiment, the computing device 1204 is the same as the computing device 104 described herein at least in connection with FIG. 1 (i.e., is a computing device such as the computing device 1502 described herein at least in connection with FIG. 15, or is a merchant computing device such as the merchant computing device 1536 described herein at least in connection with FIG. 15, or is a virtual computing device that is hosted by a service of a computing resources provider such as the computing resource provider 1528 described herein at least in connection with FIG. 15.

In an embodiment, the secured card holder 1302 interacts with systems of a dual-feature payment instrument service 1308 using an application 1306 running on the device 1304. In an embodiment, the application 1306 running on the device 1304 is an application provided by the dual-feature payment instrument service 1308 that runs on the device 1304. In an embodiment, the application 1306 can be accessed using a web page or a web portal provided by the dual-feature payment instrument service 1308 and the interactions with the dual-feature payment instrument service 1308 are displayed on the device 1304. In an embodiment, the application 1306 running on the device 1304 interacts with systems of a dual-feature payment instrument service 1308 via user elements such as those described herein at least in connection with FIG. 12.

In an embodiment, when a graduation determination system 1310 (which is the same as the graduation determination system 116 described herein at least in connection with FIG. 1) determines that a graduation from a secured dual-feature payment instrument to an unsecured dual-feature payment instrument is approved 1213, the graduation determination system 1310 sends an opt-in request 1314 to the secured card holder 1302 using systems and methods such as those described herein. In the example environment illustrated in FIG. 13, the graduation determination system 1310 sends the opt-in request 1314 to the secured card holder 1302 using the application 1306 running on the device 1304. In an embodiment, the opt-in request 1314 is displayed 1316 with additional information about the secured dual-feature payment instrument and/or the unsecured dual-feature payment instrument (e.g., the terms and conditions for the secured dual-feature payment instrument and/or the unsecured dual-feature payment instrument described herein).

In an embodiment, the application 1306 running on the device 1304 includes additional user interface elements to perform additional functions. For example, the application 1306 running on the device 1304 may include a button 1318 to decline the offer for graduation of the secured dual-feature payment instrument to an unsecured dual-feature payment instrument. In such an example, the application 1306 running on the device 1304 may send a response that declines 1320 the offer for graduation of the secured dual-feature payment instrument to an unsecured dual-feature payment instrument. In such an example, the response that declines 1320 the offer for graduation of the secured dual-feature payment instrument to an unsecured dual-feature payment instrument may be received and processed by a graduation system 1326 (which is the same as the graduation system 122 described herein at least in connection with FIG. 1) using systems and methods such as those described herein. In another example, the application 1306 running on the device 1304 may include a button 1322 to accept the offer for graduation of the secured dual-feature payment instrument to an unsecured dual-feature payment instrument. In such an example, the application 1306 running on the device 1304 may send a response that accepts 1324 the offer for graduation of the secured dual-feature payment instrument to an unsecured dual-feature payment instrument. In such an example, the response that accepts 1324 the offer for graduation of the secured dual-feature payment instrument to an unsecured dual-feature payment instrument may be received and processed by a graduation system 1326 using systems and methods such as those described herein. In an embodiment, the offer for graduation of the secured dual-feature payment instrument to an unsecured dual-feature payment instrument may be received as an email message, or as a text message, or in some other form.

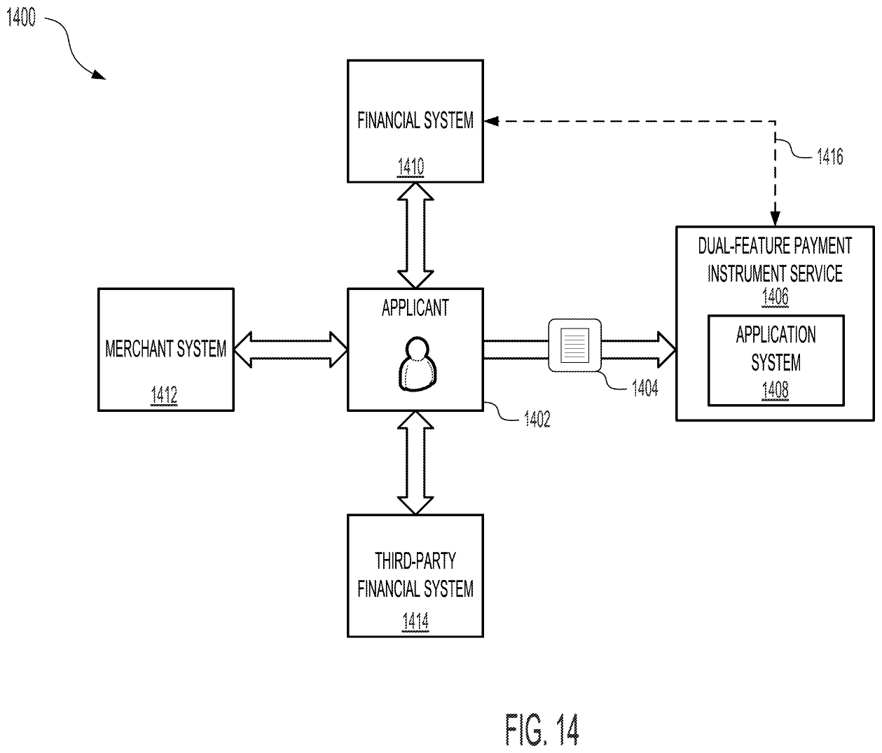

FIG. 14 shows an illustrative example of an environment 1400 in which an application for a secured dual-feature payment instrument is initiated in accordance with at least one embodiment. In an embodiment, an applicant 1402 for a secured dual-feature payment instrument (which is the applicant 202 described herein at least in connection with FIG. 2) submits an application 1404 for a secured dual-feature payment instrument to an application system 1408 (which is the same as the application system 208 described herein at least in connection with FIG. 2) of a dual-feature payment instrument service 1406 (which is the same as the dual-feature payment instrument service 108 described herein at least in connection with FIG. 1).

In an embodiment, the application 1404 for a secured dual-feature payment instrument is submitted via, in cooperation with, and/or as a result of operations of a merchant system 1412. As used herein, a merchant system 1412 is a system operated by a merchant such as the merchants described herein at least in connection with FIG. 15. In such an embodiment, the applicant 1402 may initiate the application 1404 for a secured dual-feature payment instrument due to prompting by the merchant system 1412.

In an embodiment, the application 1404 for a secured dual-feature payment instrument is submitted via, in cooperation with, and/or as a result of operations of a financial system 1410 that is associated 1416 with the dual-feature payment instrument service 1406. In such an embodiment, the applicant 1402 may initiate the application 1404 for a secured dual-feature payment instrument due to prompting by the financial system 1410 that is associated 1416 with the dual-feature payment instrument service 1406.

In an embodiment, the application 1404 for a secured dual-feature payment instrument is submitted via, in cooperation with, and/or as a result of operations of a third-party financial system 1414 that is not associated with the dual-feature payment instrument service 1406. In such an embodiment, the applicant 1402 may initiate the application 1404 for a secured dual-feature payment instrument due to prompting by the third-party financial system 1414 that is not associated with the dual-feature payment instrument service 1406.

FIG. 15 illustrates a computing system architecture 1500, including various components in electrical communication with each other, in accordance with some embodiments. The example computing system architecture 1500 illustrated in FIG. 15 includes a computing device 1502, which has various components in electrical communication with each other using a connection 1506, such as a bus, in accordance with some implementations. The example computing system architecture 1500 includes a processing unit 1504 that is in electrical communication with various system components, using the connection 1506, and including the system memory 1514. In some embodiments, the system memory 1514 includes read-only memory (ROM), random-access memory (RAM), and other such memory technologies including, but not limited to, those described herein. In some embodiments, the example computing system architecture 1500 includes a cache 1508 of high-speed memory connected directly with, in close proximity to, or integrated as part of the processor 1504. The system architecture 1500 can copy data from the memory 1514 and/or the storage device 1510 to the cache 1508 for quick access by the processor 1504. In this way, the cache 1508 can provide a performance boost that decreases or eliminates processor delays in the processor 1504 due to waiting for data. Using modules, methods and services such as those described herein, the processor 1504 can be configured to perform various actions. In some embodiments, the cache 1508 may include multiple types of cache including, for example, level one (L1) and level two (L2) cache. The memory 1514 may be referred to herein as system memory or computer system memory. The memory 1514 may include, at various times, elements of an operating system, one or more applications, data associated with the operating system or the one or more applications, or other such data associated with the computing device 1502.

Other system memory 1514 can be available for use as well. The memory 1514 can include multiple different types of memory with different performance characteristics. The processor 1504 can include any general purpose processor and one or more hardware or software services, such as service 1512 stored in storage device 1510, configured to control the processor 1504 as well as a special-purpose processor where software instructions are incorporated into the actual processor design. The processor 1504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1504 can be a microprocessor, a microcontroller, a digital signal processor (“DSP”), or a combination of these and/or other types of processors. In some embodiments, the processor 1504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1500, an input device 1516 can represent any number of input mechanisms, such as a microphone for speech, a touch-sensitive screen for gesture or graphical input, keyboard, mouse, motion input, pen, and other such input devices. An output device 1518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1500. In some embodiments, the input device 1516 and/or the output device 1518 can be coupled to the computing device 1502 using a remote connection device such as, for example, a communication interface such as the network interface 1520 described herein. In such embodiments, the communication interface can govern and manage the input and output received from the attached input device 1516 and/or output device 1518. As may be contemplated, there is no restriction on operating on any particular hardware arrangement and accordingly the basic features here may easily be substituted for other hardware, software, or firmware arrangements as they are developed.

In some embodiments, the storage device 1510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 1510 can include hardware and/or software services such as service 1512 that can control or configure the processor 1504 to perform one or more functions including, but not limited to, the methods, processes, functions, systems, and services described herein in various embodiments. In some embodiments, the hardware or software services can be implemented as modules. As illustrated in example computing system architecture 1500, the storage device 1510 can be connected to other parts of the computing device 1502 using the system connection 1506. In an embodiment, a hardware service or hardware module such as service 1512, that performs a function can include a software component stored in a non-transitory computer-readable medium that, in connection with the necessary hardware components, such as the processor 1504, connection 1506, cache 1508, storage device 1510, memory 1514, input device 1516, output device 1518, and so forth, can carry out the functions such as those described herein.

The disclosed dual-feature payment instrument service, the systems of the dual-feature payment instrument service, and the systems and methods for graduating a secured dual-feature payment instrument to an unsecured dual-feature payment instrument can be performed using a computing system such as the example computing system illustrated in FIG. 15, using one or more components of the example computing system architecture 1500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for graduating a secured dual-feature payment instrument to an unsecured dual-feature payment instrument described herein by, for example, executing code using a processor such as processor 1504 wherein the code is stored in memory such as memory 1514 as described herein. One or more of a user device, a provider server or system, a database system, or other such devices, services, or systems may include some or all of the components of the computing system such as the example computing system illustrated in FIG. 15, using one or more components of the example computing system architecture 1500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1514 can be coupled to the processor 1504 by, for example, a connector such as connector 1506, or a bus. As used herein, a connector or bus such as connector 1506 is a communications system that transfers data between components within the computing device 1502 and may, in some embodiments, be used to transfer data between computing devices. The connector 1506 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1514 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1514 can also include magnetic or optical data storage media including read-only (e.g., CD ROM and DVD ROM) or otherwise (e.g., CD or DVD). The memory can be local, remote, or distributed.

As described herein, the connector 1506 (or bus) can also couple the processor 1504 to the storage device 1510, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1506 can also couple the processor 1504 to a network interface device such as the network interface 1520. The interface can include one or more of a modem or other such network interfaces including, but not limited to those described herein. It will be appreciated that the network interface 1520 may be considered to be part of the computing device 1502 or may be separate from the computing device 1502. The network interface 1520 can include one or more of an analog modem, Integrated Services Digital Network (ISDN) modem, cable modem, token ring interface, satellite transmission interface, or other interfaces for coupling a computer system to other computer systems. In some embodiments, the network interface 1520 can include one or more input and/or output (I/O) devices. The I/O devices can include, by way of example but not limitation, input devices such as input device 1516 and/or output devices such as output device 1518. For example, the network interface 1520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1502 can be connected to one or more additional computing devices such as computing device 1524 via a network 1522 using a connection such as the network interface 1520. In such embodiments, the computing device 1524 may execute one or more services 1526 to perform one or more functions under the control of, or on behalf of, programs and/or services operating on computing device 1502. In some embodiments, a computing device such as computing device 1524 may include one or more of the types of components as described in connection with computing device 1502 including, but not limited to, a processor such as processor 1504, a connection such as connection 1506, a cache such as cache 1508, a storage device such as storage device 1510, memory such as memory 1514, an input device such as input device 1516, and an output device such as output device 1518. In such embodiments, the computing device 1524 can carry out the functions such as those described herein in connection with computing device 1502. In some embodiments, the computing device 1502 can be connected to a plurality of computing devices such as computing device 1524, each of which may also be connected to a plurality of computing devices such as computing device 1524. Such an embodiment may be referred to herein as a distributed computing environment.

The network 1522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1522 can be wired connections, wireless connections, or combinations thereof. Communications via the network 1522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1522, within the computing device 1502, within the computing device 1524, or within the computing resources provider 1528 can include information, which also may be referred to herein as content. The information may include text, graphics, audio, video, haptics, and/or any other information that can be provided to a user of the computing device such as the computing device 1502. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1502 and presented to a user of the computing device 1502 using forms that are perceptible via sight, sound, smell, taste, touch, or other such mechanisms. In some embodiments, communications over the network 1522 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1502 and/or the computing device 1524 can be connected to a computing resources provider 1528 via the network 1522 using a network interface such as those described herein (e.g. network interface 1520). In such embodiments, one or more systems (e.g., service 1530 and service 1532) hosted within the computing resources provider 1528 (also referred to herein as within “a computing resources provider environment”) may execute one or more services to perform one or more functions under the control of, or on behalf of, programs and/or services operating on computing device 1502 and/or computing device 1524. Systems such as service 1530 and service 1532 may include one or more computing devices such as those described herein to execute computer code to perform the one or more functions under the control of, or on behalf of, programs and/or services operating on computing device 1502 and/or computing device 1524.

For example, the computing resources provider 1528 may provide a service, operating on service 1530 to store data for the computing device 1502 when, for example, the amount of data that the computing device 1502 exceeds the capacity of storage device 1510. In another example, the computing resources provider 1528 may provide a service to first instantiate a virtual machine (VM) on service 1532, use that VM to access the data stored on service 1532, perform one or more operations on that data, and provide a result of those one or more operations to the computing device 1502. Such operations (e.g., data storage and VM instantiation) may be referred to herein as operating “in the cloud,” “within a cloud computing environment,” or “within a hosted virtual machine environment,” and the computing resources provider 1528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1530 and service 1532 may implement versions of various services (e.g., the service 1512 or the service 1526) on behalf of, or under the control of, computing device 1502 and/or computing device 1524. Such implemented versions of various services may involve one or more virtualization techniques so that, for example, it may appear to a user of computing device 1502 that the service 1512 is executing on the computing device 1502 when the service is executing on, for example, service 1530. As may also be contemplated, the various services operating within the computing resources provider 1528 environment may be distributed among various systems within the environment as well as partially distributed onto computing device 1524 and/or computing device 1502.

In an embodiment, the computing device 1502 can be connected to one or more additional computing devices and/or services such as merchant computing device 1536 and/or a point-of-sale service 1534 via the network 1522 and using a connection such as the network interface 1520. In an embodiment, the point-of-sale service 1534 is separate from the merchant computing device 1536. In an embodiment, the point-of-sale service 1534 is executing on the merchant computing device 1536. In an embodiment, the point-of-sale service 1534 is executing as one or more services (e.g., the service 1530 and/or the service 1532) operating within the environment of the computing resources provider. As used herein, a point-of-sale service 1534 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 1536 to interact with the point-of-sale service 1534. In an embodiment, the merchant computing device 1536 is a dedicated point-of-service (POS) terminal. In an embodiment, the merchant computing device 1536 is a cash register system. In an embodiment, the merchant computing device 1536 is an application or web service operating on a computing device such as the computing device 1502 described herein. In such an embodiment, the application or web service may be provided by a financial services system (e.g., a bank, a transaction processing system, an inventory management system, or some other such financial services system). In an embodiment, the merchant computing device 1536 includes an auxiliary device or system to execute tasks associated with the point-of-sale service 1534 (e.g., a payment instrument processing device attached to a smart phone or tablet). In an embodiment, the merchant computing device 1536 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 1536 is a virtual device (e.g., a virtual kiosk) such as the virtual devices described herein. Although not illustrated here, in an embodiment, the merchant computing device 1536 may be one of a plurality of devices that may be interconnected using a network such as the network 1522.

In an embodiment, the computing device 1502 can be connected to one or more additional computing devices and/or services such as a payment instrument service 1538 via the network 1522 and using a connection such as the network interface 1520. In an embodiment, the payment instrument service 1538 connects directly with the point of sale service 1534. In an embodiment, elements of the payment instrument service 1538 are executing on the merchant computing device 1536. In an embodiment, the payment instrument service 1538 is executing as one or more services (e.g., the service 1530 and/or the service 1532) operating within the environment of the computing resources provider. As used herein, a payment instrument service 1538 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 1538 are running as an application or web service operating on a computing device such as the computing device 1502 described herein. In such an embodiment, the application or web service of the payment instrument service 1538 may be provided by a financial services system (e.g., a bank, a transaction processing system, an inventory management system, or some other such financial services system). In an embodiment, elements of the payment instrument service 1538 are running on an auxiliary device or system configured to execute tasks associated with the payment instrument service 1538 (e.g., uses a payment instrument processing device attached to a smart phone or tablet). In an embodiment, elements of the payment instrument service 1538 are running on virtual device such as those described herein. Although not illustrated here, in an embodiment, the payment instrument service 1538 may be running on one or more of a plurality of devices that may be interconnected using a network such as the network 1522.

In an embodiment, the computing device 1502 can be connected to one or more additional computing devices and/or services such as an authentication service 1540 via the network 1522 and using a connection such as the network interface 1520. In an embodiment, the authentication service 1540 is an element of the payment instrument service 1538. In an embodiment, the authentication service 1540 is separate from the payment instrument service 1538. In an embodiment, the authentication service 1540 connects directly with the point of sale service 1534. In an embodiment, elements of the authentication service 1540 are executing on the merchant computing device 1536. In an embodiment, the authentication service 1540 is executing as one or more services (e.g., the service 1530 and/or the service 1532) operating within the environment of the computing resources provider. As used herein, an authentication service 1540 is a service used by one or more merchants to authenticate transactions associated with payment instruments. An authentication service may be a third-party service that provides secure and verified authorization of the transactions.

In an embodiment, elements of the authentication service 1540 are running as an application or web service operating on a computing device such as the computing device 1502 described herein. In such an embodiment, the application or web service of the authentication service 1540 may be provided by a financial services system (e.g., a bank, a transaction processing system, an inventory management system, or some other such financial services system). In an embodiment, elements of the authentication service 1540 are running on an auxiliary device or system configured to execute tasks associated with the authentication service 1540 (e.g., provides authentication using payment instrument processing device attached to a smart phone or tablet). In an embodiment, elements of the authentication service 1540 are running on virtual device such as those described herein. Although not illustrated here, in an embodiment, the authentication service 1540 may be running on one or more of a plurality of devices that may be interconnected using a network such as the network 1522.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1502) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 500 for offering graduation of a secured dual-feature payment instrument to an unsecured dual-feature payment instrument to an account holder illustrated in FIG. 5). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1502.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
generating a secured dual-feature payment instrument, wherein the secured dual-feature payment instrument is secured by a security deposit, and wherein the secured dual-feature payment instrument is associated with a user account;
associating a computational model with the user account and an account holder;
updating the computational model by continually applying a machine learning model to one or more transactions associated with the user account and the account holder;
using the computational model to determine whether to generate an offer to graduate the secured dual-feature payment instrument to an unsecured dual-feature payment instrument;
communicating the offer to graduate the secured dual-feature payment instrument to the unsecured dual-feature payment instrument, wherein when the offer is received by the account holder, the account holder determines whether to provide an acceptance of the offer;
receiving the acceptance of the offer; and
graduating the secured dual-feature payment instrument to the unsecured dual-feature payment instrument.

2. The computer-implemented method of claim 1, wherein the transactions associated with the user account and the account holder include transactions conducted using the secured dual-feature payment instrument.

3. The computer-implemented method of claim 1, wherein the transactions associated with the user account and the account holder include transactions reported to a credit reporting service.

4. The computer-implemented method of claim 1, further comprising:
returning the security deposit to the account holder in response to receiving the acceptance of the offer.

5. The computer-implemented method of claim 1, further comprising:
updating the computational model using one or more financial rules, wherein the one or more financial rules are associated with a financial institution associated with the user account.

6. The computer-implemented method of claim 1, further comprising:
determining a future time to communicate the offer to graduate the secured dual-feature payment instrument to the unsecured dual-feature payment instrument, wherein the future time is determined using the computational model.

7. The computer-implemented method of claim 1, further comprising:
providing the account holder with a set of terms and conditions associated with the secured dual-feature payment instrument when providing the secured dual-feature payment instrument to the holder of the account; and
providing the account holder with the set of terms and conditions associated with the secured dual-feature payment instrument when communicating the offer of graduation.

8. A system, comprising:
one or more processors; and
memory storing thereon instructions that, as a result of being executed by the one or more processors, cause the system to:
generate a secured dual-feature payment instrument, wherein the secured dual-feature payment instrument is secured by a security deposit, and wherein the secured dual-feature payment instrument is associated with a user account;
associate a computational model with the user account and an account holder;
update the computational model by continually applying a machine learning model to one or more transactions associated with the user account and the account holder;
use the computational model to determine whether to generate an offer to graduate the secured dual-feature payment instrument to an unsecured dual-feature payment instrument;
communicate the offer to graduate the secured dual-feature payment instrument to the unsecured dual-feature payment instrument, wherein when the offer is received by the account holder, the account holder determines whether to provide an acceptance of the offer;
receive the acceptance of the offer; and
graduate the secured dual-feature payment instrument to the unsecured dual-feature payment instrument.

9. The system of claim 8, wherein the transactions associated with the user account and the account holder include transactions conducted using the secured dual-feature payment instrument.

10. The system of claim 8, wherein the transactions associated with the user account and the account holder include transactions reported to a credit reporting service.

11. The system of claim 8, wherein the instructions further include instructions that, as a result of being executed by the one or more processors, cause the system to:
return the security deposit to the account holder in response to receiving the acceptance of the offer.

12. The system of claim 8, wherein the instructions further include instructions that, as a result of being executed by the one or more processors, cause the system to:
update the computational model using one or more financial rules, wherein the one or more financial rules are associated with a financial institution associated with the user account.

13. The system of claim 8, wherein the instructions further include instructions that, as a result of being executed by the one or more processors, cause the system to:
determine a future time to communicate the offer to graduate the secured dual-feature payment instrument to the unsecured dual-feature payment instrument, wherein the future time is determined using the computational model.

14. The system of claim 8, wherein the instructions further include instructions that, as a result of being executed by the one or more processors, cause the system to:
provide the account holder with a set of terms and conditions associated with the secured dual-feature payment instrument when providing the secured dual-feature payment instrument to the holder of the account; and
provide the account holder with the set of terms and conditions associated with the secured dual-feature payment instrument when communicating the offer of graduation.

15. A non-transitory, computer-readable storage medium storing thereon executable instructions that, as a result of being executed by a computer system, cause the computer system to:
generate a secured dual-feature payment instrument, wherein the secured dual-feature payment instrument is secured by a security deposit, and wherein the secured dual-feature payment instrument is associated with a user account;
associate a computational model with the user account and an account holder;
update the computational model by continually applying a machine learning model to one or more transactions associated with the user account and the account holder;
use the computational model to determine whether to generate an offer to graduate the secured dual-feature payment instrument to an unsecured dual-feature payment instrument;
communicate the offer to graduate the secured dual-feature payment instrument to the unsecured dual-feature payment instrument, wherein when the offer is received by the account holder, the account holder determines whether to provide an acceptance of the offer;
receive the acceptance of the offer; and
graduate the secured dual-feature payment instrument to the unsecured dual-feature payment instrument.

16. The non-transitory, computer-readable storage medium of claim 15, wherein the transactions associated with the user account and the account holder include transactions conducted using the secured dual-feature payment instrument.

17. The non-transitory, computer-readable storage medium of claim 15, wherein the transactions associated with the user account and the account holder include transactions reported to a credit reporting service.

18. The non-transitory, computer-readable storage medium of claim 15, wherein the executable instructions further comprising instructions that, as a result of being executed by a computer system, cause the computer system to:
return the security deposit to the account holder in response to receiving the acceptance of the offer.

19. The non-transitory, computer-readable storage medium of claim 15, wherein the executable instructions further comprising instructions that, as a result of being executed by a computer system, cause the computer system to:
update the computational model using one or more financial rules, wherein the one or more financial rules are associated with a financial institution associated with the user account.

20. The non-transitory, computer-readable storage medium of claim 15, wherein the executable instructions further comprising instructions that, as a result of being executed by a computer system, cause the computer system to:
determine a future time to communicate the offer to graduate the secured dual-feature payment instrument to the unsecured dual-feature payment instrument, wherein the future time is determined using the computational model.

21. The non-transitory, computer-readable storage medium of claim 15, wherein the executable instructions further comprising instructions that, as a result of being executed by a computer system, cause the computer system to:
provide the account holder with a set of terms and conditions associated with the secured dual-feature payment instrument when providing the secured dual-feature payment instrument to the holder of the account; and
provide the account holder with the set of terms and conditions associated with the secured dual-feature payment instrument when communicating the offer of graduation.
